(19) United States
(12) Patent Application Publication
(10) Pub. No.: US 2026/0084424 A1
(43) Pub. Date: Mar. 26, 2026

(54) HEAD CHIP, LIQUID JET HEAD, AND LIQUID JET RECORDING APPARATUS

(71) Applicant: SII Printek Inc., Chiba-shi, Chiba (JP)

(72) Inventor: Hitoshi NAKAYAMA, Chiba-shi (JP)

(21) Appl. No.: 19/336,855

(22) Filed: Sep. 23, 2025

(30) Foreign Application Priority Data
Sep. 25, 2024 (JP) 2024-166119

(51) Int. Cl. B41J 2/14

(52) U.S. Cl. CPC B41J 2/14209; B41J 2002/14217

(57) ABSTRACT

A head chip, a liquid jet head, and a liquid jet recording apparatus each capable of suppressing short circuit between a common electrode and an individual electrode are provided. The head chip according to the present disclosure includes an actuator plate which has a first surface facing a plurality of pressure chambers containing a liquid, and a second surface facing an opposite side to the pressure chambers with respect to the first surface in a thickness direction, and in which a recessed portion is provided on at least one surface out of the first surface and the second surface, a common electrode provided to the first surface, and configured to function as a reference potential, and an individual electrode provided to the second surface which is a surface other than the first surface, and configured to generate a potential difference relative to the common electrode to generate an electric field in the actuator plate. An electrode which is one of the common electrode and the individual electrode and is provided to the one surface is provided on at least an inner surface of the recessed portion.

### RELATED APPLICATIONS

This application claims priority to Japanese Patent application No. JP2024-166119, filed on Sep. 25, 2024, the entire content of which is incorporated herein by reference.

### BACKGROUND OF THE INVENTION

### 1. Field of the Invention

The present disclosure relates to a head chip, a liquid jet head, and a liquid jet recording apparatus.

### 2. Description of the Related Art

In a head chip installed in an inkjet printer, an electric field is generated in an actuator plate formed of a piezoelectric material to deform the actuator plate to thereby generate a pressure variation in a pressure chamber. Thus, ink contained in the pressure chamber is ejected through a nozzle hole.

For example, JP7220327B discloses a configuration in which an actuator plate and a nozzle plate are arranged so as to be opposed to each other, and pressure chambers are formed between the actuator plate and the nozzle plate.

On a lower surface (a surface facing the pressure chambers) of the actuator plate, there are formed common electrodes and individual electrodes. It is arranged that the common electrodes and the individual electrodes are prevented by a protective film (a film or an insulating layer) covering the lower surface of the actuator plate from coming into contact with ink in the pressure chambers.

However, even when the protective film is supposedly provided as in the related art, there is a possibility that a noncontiguous portion (e.g., a crack in a film, or a deposition failure in a protective layer) occurs in the protective film. In this case, there is a possibility that the ink enters between the protective film and the lower surface of the actuator plate through the noncontiguous portion to thereby cause short circuit between the common electrode and the individual electrode and so on.

The present disclosure provides a head chip, a liquid jet head, and a liquid jet recording apparatus each capable of suppressing short circuit between the common electrode and the individual electrode.

### SUMMARY OF THE INVENTION

In order to solve the problems described above, the present disclosure adopts the following aspects.

(1) A head chip according to an aspect of the present disclosure includes an actuator plate which has a first surface facing a plurality of pressure chambers containing a liquid, and a second surface facing an opposite side to the pressure chambers with respect to the first surface in a thickness direction, and in which a recessed portion is provided on at least one surface out of the first surface and the second surface, a common electrode provided to the first surface, and configured to function as a reference potential, and an individual electrode provided to the second surface which is a surface other than the first surface, and configured to generate a potential difference relative to the common electrode to generate an electric field in the actuator plate, wherein an electrode which is one of the common electrode and the individual electrode and is provided to the one surface is provided on at least an inner surface of the recessed portion.

According to the present aspect, since the recessed portion is provided to the actuator plate, it is easy to ensure the rigidity of the entire actuator plate. Therefore, it is possible to achieve an increase in manufacturing efficiency and an increase in yield ratio. On that basis, in the present aspect, since one electrode is also formed in the recessed portion, it is possible to ensure the surface area of the one electrode, and at the same time, it is easy to ensure the facing area between the first electrode and the second electrode. Therefore, it is easy to increase the pressure generated in the pressure chamber when jetting the liquid.

In particular, in the present aspect, since the individual electrode is formed on the second surface which is a surface other than the first surface, it results in that only the common electrode is formed on the first surface. Therefore, it is possible to suppress the short circuit between the common electrode and the individual electrode via the liquid compared to the configuration in which the common electrode and the individual electrode are disposed on the first surface. Thus, it is possible to provide the head chip excellent in durability and reliability.

(2) In the head chip according to aspect (1) described above, it is preferable that a polarization direction of the actuator plate is set to the thickness direction, the recessed portion is provided on each of the first surface and the second surface, a first recessed portion which is the recessed portion provided to the first surface is disposed in a portion facing the pressure chamber when viewed from the thickness direction, and a second recessed portion which is the recessed portion provided to the second surface is disposed at a position shifted from the first recessed portion when viewed from the thickness direction.

According to the present aspect, the electric field is generated in the portion (the drive portion) located in the first recessed portion and the second recessed portion in the actuator plate due to the potential difference generated between the common electrode formed in the first recessed portion and the individual electrode formed in the second recessed portion. Thus, the drive portion deforms in the thickness direction of the actuator plate 41 in a so-called shear mode. As a result, it is easy to ensure the deformation amount of the actuator plate to ensure the pressure generated in the pressure chamber.

(3) In the head chip according to aspect (2) described above, it is preferable that the individual electrode is formed on a portion of the second surface other than the second recessed portion.

According to the present aspect, by generating the potential difference between the individual electrode formed on a portion of the second surface other than the second recessed portion and the common electrode, it is possible to generate the electric field in the thickness direction (the polarization direction) of the actuator plate. Thus, it is possible to deform the actuator plate in the thickness direction in the bend mode (a bimorph type). Thus, a further increase in the generated pressure can be achieved.

(4) In the head chip according to any of aspects (1) to (3) described above, it is preferable that the common electrode is formed over an entire area of the first surface.

According to the present aspect, patterning and so on of the common electrode become unnecessary on the first surface of the actuator plate, and therefore, it is possible to achieve an increase in manufacturing efficiency and a reduction in cost.

(5) In the head chip according to any of aspects (1) to (4) described above, it is preferable that the actuator plate is formed as a unit having a polarization direction set to the thickness direction.

According to the present aspect, by using the actuator plate of a so-called monopole type in which the polarization direction is set to one direction, no junction plane exists between the piezoelectric materials unlike when, for example, the actuator plate is configured by stacking a plurality of piezoelectric materials different in polarization direction. Therefore, it is possible to suppress a bridge of the liquid between the common electrode and the individual electrode occurring through the junction interface in the actuator plate. As a result, the possibility of the short circuit can be reduced.

(6) In the head chip according to any of aspects (1) to (5) described above, it is preferable that the actuator plate is provided with a protective film configured to cover the common electrode on the first surface.

According to the present aspect, by covering the common electrode with the protective film, it is possible to suppress the contact between the common electrode and the liquid to improve the durability of the common electrode.

(7) In the head chip according to any of aspects (1) to (6) described above, it is preferable to include a jet hole plate which is penetrated, in the thickness direction, by a plurality of jet holes respectively communicated with the plurality of pressure chambers, and which is disposed so as to face the actuator plate in the thickness direction, wherein the actuator plate includes an opposed portion which has the first surface and the second surface, and is disposed in a state of being separated in the thickness direction from the jet hole plate, and a partition portion formed integrally with the opposed portion, protruding from the opposed portion in the thickness direction, and configured to separate the pressure chambers adjacent to each other, a first recessed portion which is the recessed portion provided to the first surface is disposed in a portion facing the pressure chamber when viewed from the thickness direction, a second recessed portion which is the recessed portion provided to the second surface is disposed at a position shifted from the first recessed portion when viewed from the thickness direction, the common electrode is provided to an inner surface of the first recessed portion, the individual electrode is provided to an inner surface of the second recessed portion, the opposed portion includes, in a portion located between the first recessed portion and the second recessed portion adjacent to each other, a drive portion in which an electric field is generated by the common electrode and the individual electrode, and at least a part of the partition portion is disposed at a position which does not overlap the drive portion when viewed from the thickness direction.

According to the present aspect, the electric field is generated in the drive portion due to the potential difference generated between the common electrode formed in the first recessed portion and the individual electrode formed in the second recessed portion. Thus, by the drive portion deforming in the thickness direction in the so-called shear mode, it is possible to jet the liquid through the jet hole.

In particular, in the present aspect, since at least a part of the partition portion is disposed at the position which does not overlap the drive portion when viewed from the thickness direction, it results in that a gap occurs in the thickness direction between the jet hole plate and the drive portion. Therefore, inhibition of the deformation of the drive portion by the jet hole plate and so on can be relieved when jetting the liquid. As a result, it is easy to ensure the deformation amount of the actuator plate to ensure the pressure generated in the pressure chamber.

Moreover, according to the present aspect, the partition portion also functions as at least a part of the partition portion which separates the pressure chambers adjacent to each other. Thus, it is possible to improve the position accuracy in the direction (the arrangement direction of the pressure chambers) crossing the thickness direction between the drive portion and the partition portion compared to the configuration in which the whole of the partition portion is formed of a separate member from the actuator plate.

(8) A liquid jet head according to an aspect of the present disclosure includes the head chip according to any of aspects (1) to (7) described above.

According to the present aspect, it is possible to provide a liquid jet head excellent in reliability.

(9) A liquid jet recording apparatus according to an aspect of the present disclosure includes the liquid jet head according to aspect (8) described above.

According to the present aspect, it is possible to provide a liquid jet recording apparatus excellent in reliability.

According to an aspect of the present disclosure, short circuit between the common electrode and the individual electrode can be suppressed.

### BRIEF DESCRIPTION OF THE DRAWINGS

FIG. 1 is a schematic configuration diagram of an inkjet printer according to a first embodiment.

FIG. 2 is a schematic configuration diagram of an inkjet head and an ink circulation mechanism related to the first embodiment.

FIG. 3 is an exploded perspective view of an ejection unit related to the first embodiment.

FIG. 4 is an exploded perspective view of a head chip according to the first embodiment.

FIG. 5 is a plan view of an actuator plate related to the first embodiment.

FIG. 6 is a cross-sectional view of the head chip corresponding to the line VI-VI shown in FIG. 4.

FIG. 7 is a cross-sectional view of the ejection unit corresponding to the line VII-VII shown in FIG. 6.

FIG. 8 is a cross-sectional view of the ejection unit corresponding to the line VIII-VIII shown in FIG. 6.

FIG. 9 is a bottom view of a support plate related to the first embodiment.

FIG. 10 is a plan view of the support plate related to the first embodiment.

FIG. 11 is a flowchart describing a method of manufacturing the ejection unit related to the first embodiment.

FIG. 12 is a process chart describing an actuator-first processing step, and is a cross-sectional view corresponding to FIG. 6.

FIG. 13 is a process chart describing the actuator-first processing step, and is a cross-sectional view corresponding to FIG. 6.

FIG. 14 is a process chart describing a support plate-first processing step, and is a cross-sectional view corresponding to FIG. 7.

FIG. 15 is a process chart describing the support plate-first processing step, and is a cross-sectional view corresponding to FIG. 7.

FIG. 16 is a process chart describing the support plate-first processing step, and is a cross-sectional view corresponding to FIG. 7.

FIG. 17 is a process chart describing a first bonding step, and is a cross-sectional view corresponding to FIG. 6.

FIG. 18 is a process chart describing an actuator-second processing step, and is a cross-sectional view corresponding to FIG. 6.

FIG. 19 is a process chart describing a protective film formation step, and is a cross-sectional view corresponding to FIG. 6.

FIG. 20 is a cross-sectional view of a head chip according to a second embodiment.

FIG. 21 is a cross-sectional view of a head chip according to a third embodiment.

FIG. 22 is a cross-sectional view of a head chip according to a fourth embodiment.

FIG. 23 is a cross-sectional view of a head chip according to a fifth embodiment.

FIG. 24 is a cross-sectional view of a head chip according to a sixth embodiment.

### DETAILED DESCRIPTION OF THE PREFERRED EMBODIMENTS

Some embodiments according to the present disclosure will hereinafter be described with reference to the drawings. In the embodiments and modified examples hereinafter described, constituents corresponding to each other will be denoted by the same reference symbols to omit the descriptions thereof in some cases. In the following descriptions, expressions representing relative or absolute arrangements such as “parallel,” “perpendicular,” “central,” and “coaxial” not only represent strictly such arrangements, but also represent the state of being relatively displaced with a tolerance, or an angle or a distance to the extent that the same function can be obtained. In the following embodiment, the description will be presented citing an inkjet printer (hereinafter referred to simply as a printer) for performing recording on a recording target medium using ink (a liquid) as an example. The scale size of each member is arbitrarily modified so as to provide a recognizable size to the member in the drawings used in the following description.

### First Embodiment

### [Printer 1]

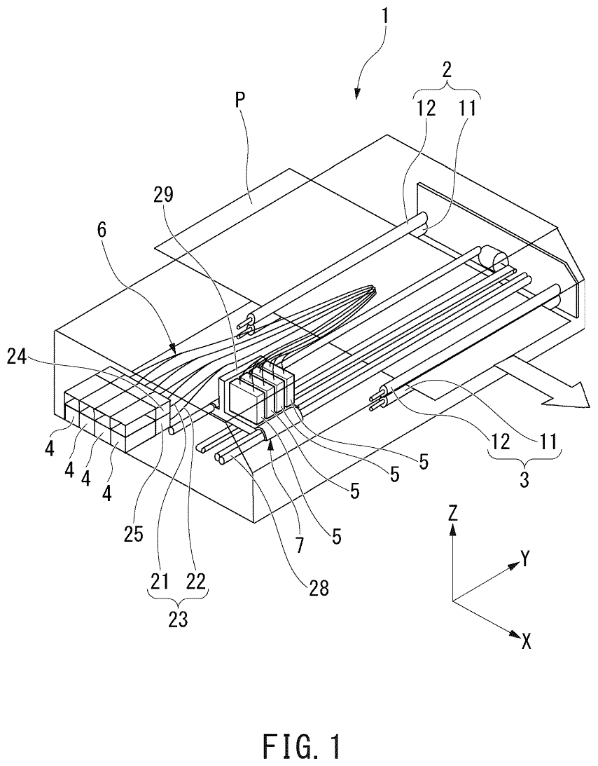

FIG. 1 is a schematic configuration diagram of a printer 1.

The printer (a liquid jet recording apparatus) 1 shown in FIG. 1 is provided with a pair of conveyance mechanisms 2, 3, ink tanks 4, inkjet heads (liquid jet heads) 5, ink circulation mechanisms 6, and a scanning mechanism 7.

In the following explanation, the description is presented using an orthogonal coordinate system of X, Y, and Z as needed. In this case, the X direction coincides with a conveyance direction (a sub-scanning direction) of a recording target medium P (e.g., paper). The Y direction coincides with a scanning direction (a main scanning direction) of the scanning mechanism 7. The Z direction represents a height direction (a gravitational direction) perpendicular to the X direction and the Y direction. In the following explanation, the description will be presented defining an arrow side as a positive (+) side, and an opposite side to the arrow as a negative (−) side in the drawings in each of the X direction, the Y direction, and the Z direction. In the present specification, the +Z side corresponds to an upper side in the gravitational direction, and the −Z side corresponds to a lower side in the gravitational direction.

The conveyance mechanisms 2, 3 convey the recording target medium P toward the +X side. The conveyance mechanisms 2, 3 each include a pair of rollers 11, 12 extending in, for example, the Y direction.

In the ink tanks 4, there are individually contained four colors of ink such as yellow ink, magenta ink, cyan ink, and black ink. The inkjet heads 5 are configured so as to be able to respectively eject the four colors of ink, namely the yellow ink, the magenta ink, the cyan ink, and the black ink in accordance with the ink tanks 4 coupled thereto.

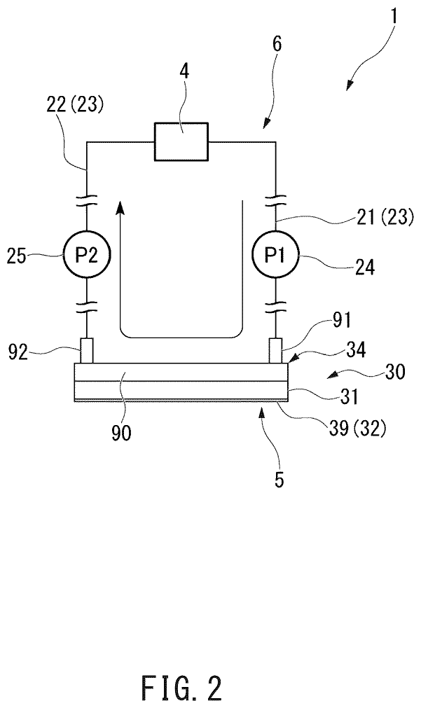

FIG. 2 is a schematic configuration diagram of the inkjet head 5 and the ink circulation mechanism 6.

As shown in FIGS. 1 and 2, the ink circulation mechanism 6 circulates the ink between the ink tank 4 and the inkjet head 5. Specifically, the ink circulation mechanism 6 is provided with a circulation flow path 23 having an ink supply tube 21 and an ink discharge tube 22, a pressure pump 24 coupled to the ink supply tube 21, and a suction pump 25 coupled to the ink discharge tube 22.

The pressure pump 24 pressurizes an inside of the ink supply tube 21 to deliver the ink to the inkjet head 5 through the ink supply tube 21. Thus, the ink supply tube 21 is provided with positive pressure with respect to the inkjet head 5.

The suction pump 25 depressurizes the inside of the ink discharge tube 22 to suction the ink from the inkjet head 5 through the ink discharge tube 22. Thus, the ink discharge tube 22 side is provided with negative pressure with respect to the inkjet head 5. It is arranged that the ink can circulate between the inkjet head 5 and the ink tank 4 through the circulation flow path 23 by driving the pressure pump 24 and the suction pump 25.

As shown in FIG. 1, the scanning mechanism 7 reciprocates the inkjet heads 5 in the Y direction. The scanning mechanism 7 is provided with a guide rail 28 extending in the Y direction, and a carriage 29 movably supported by the guide rail 28.

<inkjet Heads 5>

The inkjet heads 5 are mounted on the carriage 29. In the illustrated example, the plurality of inkjet heads 5 is mounted on the single carriage 29 so as to be arranged side by side in the Y direction. The inkjet heads 5 are each provided with an ejection unit 30 (see FIG. 2), an ink supply unit (not shown) for coupling the ink circulation mechanism 6 and the ejection unit 30, and a control unit (not shown) for applying drive voltages to the ejection unit 30.

### First Embodiment

### [Ejection Unit 30]

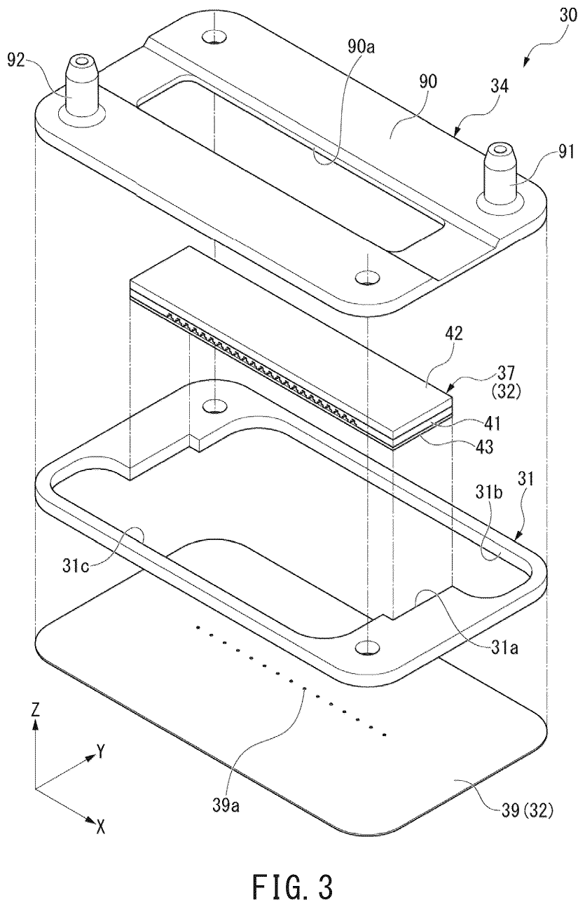

FIG. 3 is an exploded perspective view of the ejection unit 30.

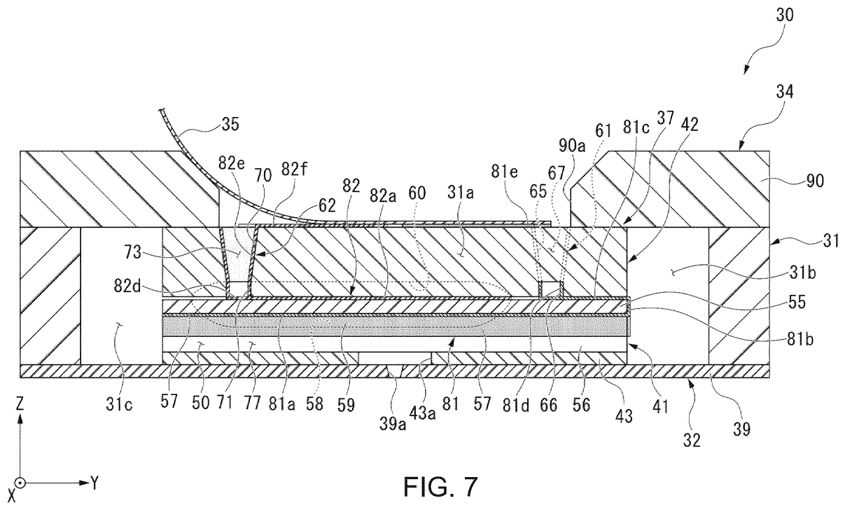

The ejection unit 30 shown in FIG. 3 is a so-called recirculating side-shoot type ejection unit 30 which circulates the ink with the ink tank 4, and at the same time, ejects the ink from a central portion in the extending direction (the Y direction) in a pressure chamber 50. The ejection unit 30 is provided with a flow path frame member 31, a head chip 32, a flow path cover 34, and a flexible printed board 35 (see FIG. 7).

### <Flow Path Frame Member 31>

The flow path frame member 31 is formed to have a rectangular frame shape having a thickness direction set to the Z direction, and a longitudinal direction set to the X direction. The flow path frame member 31 separates a chip housing portion 31a, an entrance common flow path 31b, and an exit common flow path 31c. The chip housing portion 31a, the entrance common flow path 31b, and the exit common flow path 31c penetrate the flow path frame member 31 in the Z direction in a state of communicating with each other.

The chip housing portion 31a is formed in a central portion in the Y direction in the flow path frame member 31. The chip housing portion 31a is formed in an elongated hole shape having a longitudinal direction set to the X direction in a plan view.

The entrance common flow path 31b is formed in a portion of the flow path frame member 31, the portion being located at the +Y side with respect to the chip housing portion 31a. Similarly to the chip housing portion 31a, the entrance common flow path 31b is formed in an elongated hole shape having a longitudinal direction set to the X direction. A +X-side end portion in the entrance common flow path 31b protrudes toward the X direction with respect to the chip housing portion 31a.

The exit common flow path 31c is formed in a portion of the flow path frame member 31, the portion being located at the −Y side with respect to the chip housing portion 31a. Similarly to the entrance common flow path 31b, the exit common flow path 31c is formed in an elongated hole shape having a longitudinal direction set to the X direction. A −X-side end portion in the exit common flow path 31c protrudes toward the X direction with respect to the chip housing portion 31a.

<head Chip 32>

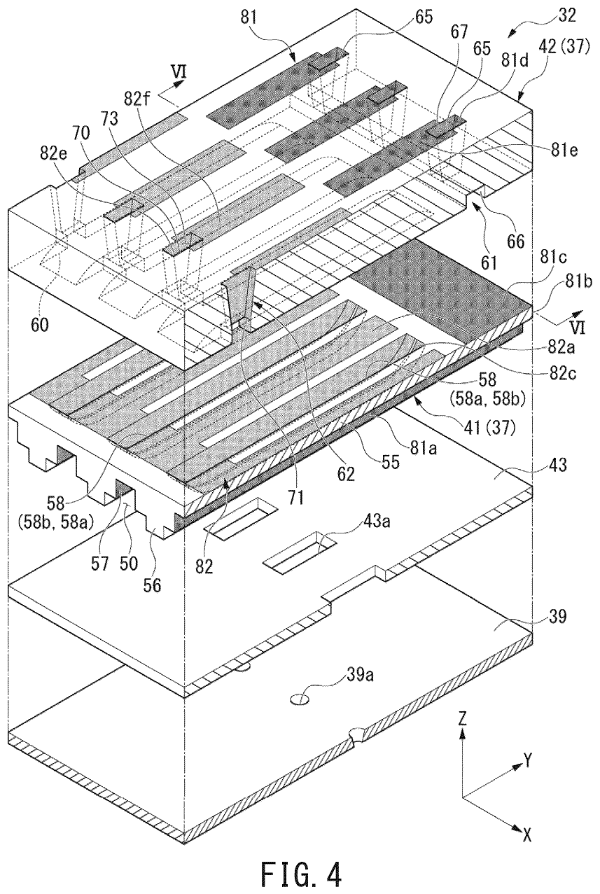

FIG. 4 is an exploded perspective view of the head chip 32.

As shown in FIG. 4, the head chip 32 is provided with a plurality of pressure chambers 50, in which the ink is housed, arranged in the X direction, and at the same time, ejects the ink from the pressure chambers 50 through nozzle holes 39a respectively communicating with the pressure chambers 50 due to pressure changes in the pressure chambers 50. The head chip 32 is provided with a chip module 37 and a nozzle plate 39.

As shown in FIG. 3, the chip module 37 is formed to have a block shape having a thickness direction set to the Z direction, and a longitudinal direction set to the X direction. The chip module 37 is fitted in the chip housing portion 31a. Specifically, the chip module 37 is formed to have a thickness in the Z direction equivalent to that of the flow path frame member 31, and a planar shape equivalent to that of the chip housing portion 31a. In this case, a +X-side end surface of the chip module 37 is fixed to a surface facing the −X side out of inner surfaces of the chip housing portion 31a with an adhesive or the like, and a −X-side end surface of the chip module 37 is fixed to a surface facing the −X side out of the inner surfaces of the chip housing portion 31a with an adhesive or the like. Therefore, in the flow path frame member 31, the entrance common flow path 31b and the exit common flow path 31c are separated by the chip module 37.

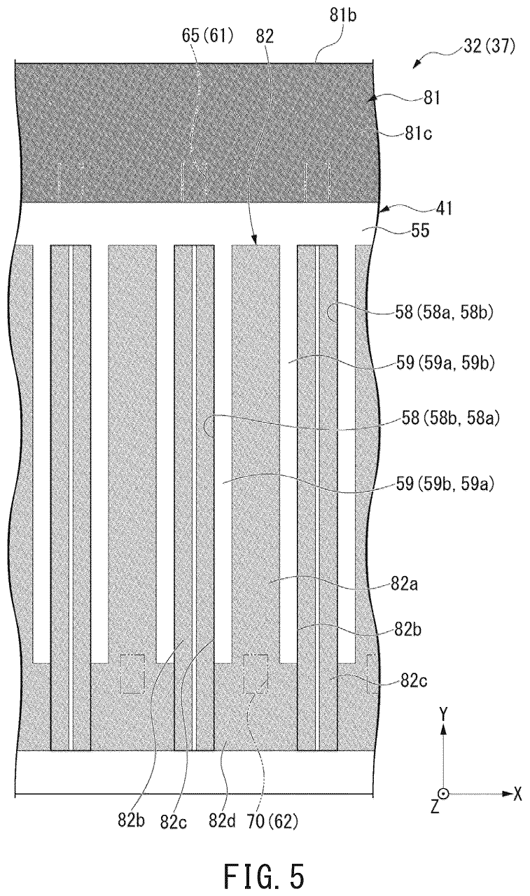

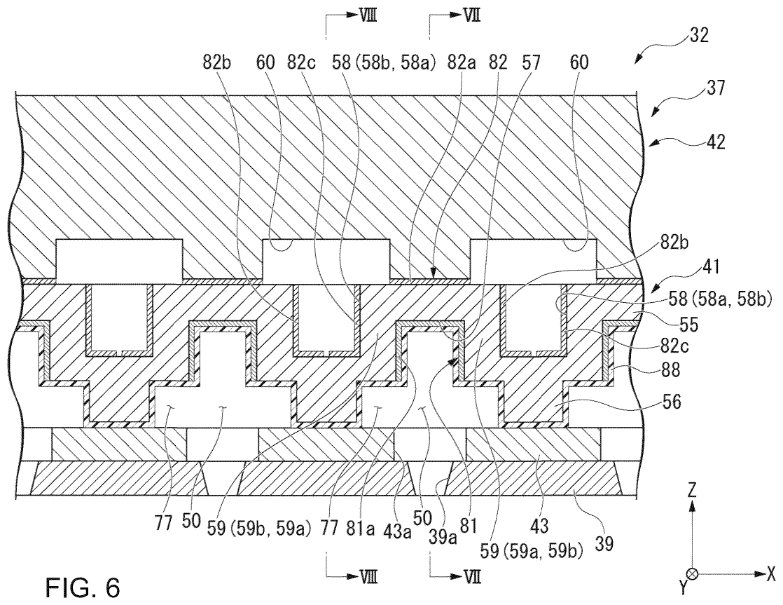

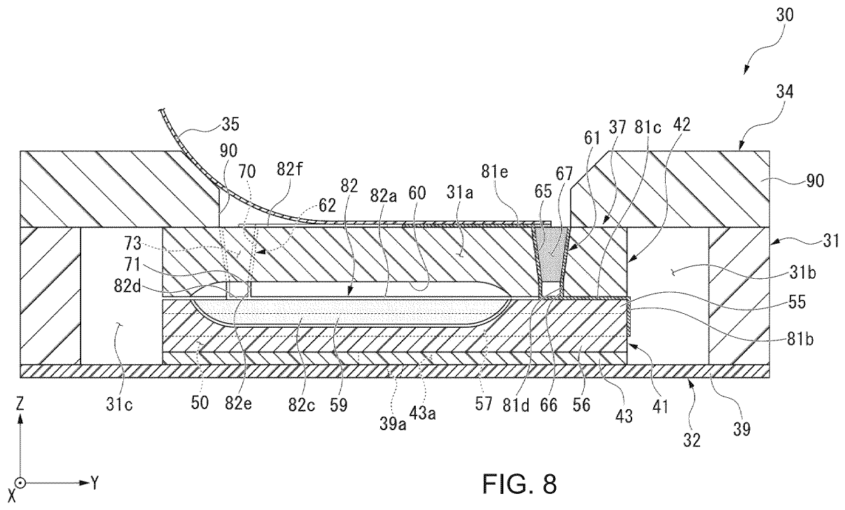

FIG. 5 is a plan view of an actuator plate 41. FIG. 6 is a cross-sectional view of the head chip 32 corresponding to the line VI-VI shown in FIG. 4. FIG. 7 is a cross-sectional view of the ejection unit 30 corresponding to the line VII-VII shown in FIG. 6. FIG. 8 is a cross-sectional view of the ejection unit 30 corresponding to the line VIII-VIII shown in FIG. 6.

As shown in FIG. 4 to FIG. 8, the chip module 37 is provided with the actuator plate 41, a support plate 42, and an intermediate plate 43. The chip module 37 is configured with the intermediate plate 43, the actuator plate 41, and the support plate 42 stacked on one another in this order. In the following explanation, the description is presented in some cases defining a direction (+Z side) from the intermediate plate 43 toward the support plate 42 along the Z direction as an upper side, and a direction (−Z side) from the support plate 42 toward the intermediate plate 43 along the Z direction as a lower side. In the first embodiment, a lower surface of the head chip 32 is arranged so as to be coplanar with a lower surface of the flow path frame member 31. Meanwhile, an upper surface of the head chip 32 is arranged so as to be coplanar with an upper surface of the flow path frame member 31.

<actuator Plate 41>

The actuator plate 41 constitutes a part of the pressure chamber 50, and at the same time, causes a pressure change in the pressure chamber 50 when ejecting the ink. The actuator plate 41 is formed of a piezoelectric material such as PZT (lead zirconate titanate). As the actuator plate 41, there is used, for example, a so-called monopole substrate in which the polarization direction is unidirectional throughout the entire area in the Z direction. In other words, the actuator plate 41 is formed as a unit without any junction interfaces. It should be noted that as the actuator plate 41, there may be used a so-called chevron substrate formed by stacking two piezoelectric plates different in polarization direction in the Z direction from each other on one another.

The actuator plate 41 is provided with an opposed portion 55 and partition portions 56.

The opposed portion 55 is formed to have a plate shape having a thickness direction set to the Z direction. The opposed portion 55 constitutes a top wall of each of the pressure chambers 50. Specifically, the opposed portion 55 is located above all the pressure chambers 50 so as to straddle the pressure chambers 50.

The partition portions 56 protrude downward from the opposed portion 55, and at the same time, extend in parallel to each other over the entire length in the Y direction in the opposed portion 55. The partition portion 56 separates the pressure chambers 50 adjacent to each other in the X direction. In other words, the partition portion 56 constitutes a sidewall of the pressure chamber 50.

In the opposed portion 55, recessed portions 57 are each formed in a portion located between the partition portions 56 adjacent to each other in the X direction. The recessed portion 57 opens on a lower surface of the opposed portion 55, and at the same time, extends linearly over the entire length in the Y direction in the opposed portion 55. The recessed portion 57 also functions as a part of the pressure chamber 50.

As shown in FIG. 6, the width in the X direction of the recessed portion 57 is made narrower than a distance between the partition portions 56 adjacent to each other. Further, the recessed portion 57 is disposed at a position which includes the center in the X direction of the pressure chamber 50, and is not in contact with the partition portion 56. Therefore, the pressure chamber 50 is formed to have a step shape in which the width in the X direction in a portion located at an upper side is narrower than the width in the X direction of a portion located at a lower side in the cross-sectional view shown in FIG. 6. It should be noted that in the first embodiment, the center in the X direction in the recessed portion 57 coincides with the center in the X direction in the pressure chamber 50.

Further, the depth in the Z direction in the recessed portion 57 is set no smaller than the thickness in the Z direction in the opposed portion 55, and no smaller than the height in the Z direction in the partition portion 56. However, the depth in the Z direction in the recessed portion 57 can appropriately be changed.

In the opposed portion 55, decoupling grooves 58 are each formed in a portion located between the recessed portions 57 adjacent to each other in the X direction. The decoupling groove 58 opens on an upper surface of the opposed portion 55, and at the same time, extends linearly in the Y direction. Therefore, the decoupling grooves 58 and the recessed portions 57 are alternately arranged (at positions shifted from each other when viewed from the Z direction) in the X direction, and extend in parallel to each other in the plan view. Both end portions in the Y direction in the decoupling groove 58 are not opened on both end surfaces in the Y direction in the opposed portion 55.

As shown in FIG. 6, the decoupling groove 58 is formed so that the width in the X direction is smaller than a distance between the recessed portions 57 adjacent to each other. Further, the decoupling groove 58 is disposed at a position which includes the center in the X direction of the partition portion 56, and is not in contact with the recessed portion 57. It should be noted that in the first embodiment, the decoupling groove 58 is formed so that the center in the X direction coincides with the center in the X direction in the partition portion 56, and the width in the X direction is narrower than the width in the X direction in the partition portion 56. Therefore, the whole of the decoupling groove 58 overlaps the whole of the partition portion 56 in the plan view. It should be noted that the width of the decoupling groove 58 may be no smaller than the width of the partition portion 56. Further, it is sufficient for the partition portion 56 and the decoupling groove 58 to at least partially overlap each other in the plan view.

The decoupling groove 58 is formed so that the depth in the Z direction is no smaller than half the thickness in the Z direction in the opposed portion 55. Therefore, the decoupling groove 58 and the recessed portion 57 partially overlap each other (in the Z direction) when viewed from the X direction.

In the first embodiment, the pressure chamber 50 is surrounded by the partition portions 56 adjacent to each other, and a part of the opposed portion 55 located between the partition portions 56 adjacent to each other. The pressure chamber 50 extends linearly in the Y direction over the entire length of the actuator plate 41. A +Y-side opening portion in the pressure chamber 50 is communicated individually with the entrance common flow path 31b. A −Y-side opening portion in each of the pressure chambers 50 is communicated individually with the exit common flow path 31c. In other words, the entrance common flow path 31b and the exit common flow path 31c are communicated with each other via the pressure chambers 50.

In the opposed portion 55, a portion located between the recessed portion 57 and the decoupling groove 58 adjacent to each other in the X direction constitutes a drive portion 59. In the cross-sectional view perpendicular to the Y direction, the drive portion 59 has an equivalent thickness to the thickness of the opposed portion 55. Further, the width in the X direction in the opposed portion 55 is made narrower than those of the recessed portion 57, the decoupling groove 58, and the partition portion 56. In the illustrated example, the drive portion 59 is disposed at a position which does not overlap the whole of the partition portion 56 in the plan view. However, the drive portion 59 may partially overlap the partition portion 56 in the plan view.

The drive portions 59 are respectively disposed at positions corresponding to both end portions in the X direction with respect to one pressure chamber 50. In the following description, in some cases, the drive portion 59 located at a +X-side end portion in the pressure chamber 50 is referred to as a +X-side drive portion 59a, and the drive portion 59 located at a −X-side end portion in the pressure chamber 50 is referred to as a −X-side drive portion 59b. In the first embodiment, the +X-side drive portion 59a of one pressure chamber 50 also functions as the −X-side drive portion 59b of another pressure chamber 50 adjacent at the +X side to the one pressure chamber 50. The-X-side drive portion 59b of one pressure chamber 50 also functions as the +X-side drive portion 59a of another pressure chamber 50 adjacent at the −X side to the one pressure chamber 50.

<support Plate 42>

As shown in FIGS. 4 and 6, the support plate 42 is for ensuring the rigidity of the chip module 37, and is stacked on the actuator plate 41 to thereby support the actuator plate 41 from above. The support plate 42 is shaped like a plate formed to have an equivalent planar shape to that of the actuator plate 41. The support plate 42 is fixed to an upper surface of the actuator plate 41 (the opposed portion 55) with an adhesive or the like. In the illustrated example, the thickness of the support plate 42 is thicker than that of the actuator plate 41. However, the thickness of the support plate 42 may be thinner than that of the actuator plate 41. It should be noted that the support plate 42 can be formed of, for example, metal, metal oxide, glass, resin, or ceramics.

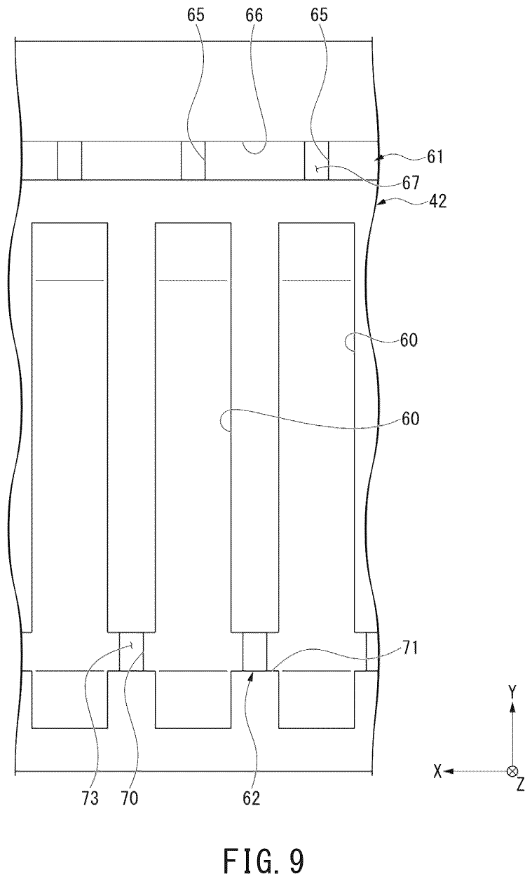

FIG. 9 is a bottom view of the support plate 42.

As shown in FIG. 6 to FIG. 9, in the support plate 42, at positions overlapping at least a part of the drive portions 59 in the plan view, there are formed deformation accepting portions 60. The deformation accepting portion 60 is a groove opening on a lower surface of the support plate 42. The deformation accepting portions 60 linearly extend in the Y direction along the pressure chamber 50 in portions located in both of the end portions (outer circumferential portions) in the X direction of the pressure chamber 50 in the plan view. Specifically, out of the deformation accepting portions 60, the deformation accepting portion 60 located at the +X side is formed so as to straddle (so as to overlap in the plan view) the whole of the +X-side drive portion 59a corresponding to one pressure chamber 50, the decoupling groove 58, and the −X-side drive portion 59b corresponding to another pressure chamber 50 adjacent to the one pressure chamber 50 in the X direction. Out of the deformation accepting portions 60, the deformation accepting portion 60 located at the −X side is formed so as to straddle (so as to overlap in the plan view) the whole of the −X-side drive portion 59b corresponding to one pressure chamber 50, the decoupling groove 58, and the +X-side drive portion 59a corresponding to another pressure chamber 50 adjacent to the one pressure chamber 50 in the X direction. Therefore, in the cross-sectional view shown in FIG. 6, the drive portions 59 and the decoupling grooves 58 are not in contact with the support plate 42.

As shown in FIGS. 7 and 8, the length in the Y direction in the deformation accepting portion 60 is made shorter than the length in the Y direction in the support plate 42. In other words, both end portions in the Y direction in the deformation accepting portion 60 are not opened on both end surfaces in the Y direction in the support plate 42. In the Y direction, the deformation accepting portion 60 is formed to have an equivalent length to the length of the decoupling groove 58. In the plan view, the deformation accepting portion 60 overlaps the whole in the Y direction of the decoupling groove 58. Therefore, in the cross-sectional view shown in FIGS. 7 and 8, the drive portions 59 and the decoupling grooves 58 are not in contact with the support plate 42. However, the dimensions of the deformation accepting portion 60 can appropriately be changed.

As shown in FIG. 4 and FIGS. 7 to 9, the support plate 42 is provided with common-use conducting portions 61 and individual-use conducting portions 62. The common-use conducting portions 61 are disposed in a +Y-side end portion of the support plate 42. The individual-use conducting portions 62 are disposed in a −Y-side end portion of the support plate 42.

The common-use conducting portions 61 are each formed in a portion located at the +Y side with respect to the deformation accepting portion 60 in the support plate 42. The common-use conducting portion 61 is provided with a common recessed portion 65 and a common interconnection groove 66.

The common recessed portion 65 opens on the upper surface of the support plate 42. The common recessed portion 65 constitutes an upper end opening portion of the common-use conducting portion 61. A plurality of common recessed portions 65 is disposed at intervals in the X direction.

The common interconnection groove 66 opens on the lower surface of the support plate 42, and at the same time, extends linearly in the X direction. In other words, the common interconnection groove 66 constitutes a lower end opening portion of the common-use conducting portion 61. The common interconnection groove 66 is disposed so as to traverse the plurality of common recessed portions 65 in the X direction. The common interconnection groove 66 is communicated with each of the common recessed portions 65 through portions overlapping the common recessed portions 65 in the plan view. In the common-use conducting portion 61, a portion with which the common recessed portion 65 and the common interconnection groove 66 are communicated constitutes a common penetration portion 67 penetrating the support plate 42 in the Z direction. It should be noted that the common interconnection groove 66 is not limited to when straddling all the common recessed portions 65, but is only required to straddle at least the common recessed portions 65 adjacent to each other.

The individual-use conducting portion 62 is formed at a position overlapping, for example, a −Y-side end portion of the deformation accepting portion 60 in the plan view in the support plate 42. The individual-use conducting portion 62 is provided with an individual recessed portion 70 and an individual interconnection groove 71.

The individual recessed portion 70 opens on the upper surface of the support plate 42. The individual recessed portion 70 constitutes an upper end opening portion of the individual-use conducting portion 62. A plurality of individual recessed portions 70 is disposed at intervals in the X direction. In the first embodiment, the common recessed portions 65 and the individual recessed portions 70 are arranged alternately in the X direction at positions different in the Y direction from each other. However, the position of the common recessed portion 65 with respect to the individual recessed portion 70 can appropriately be changed.

The individual interconnection groove 71 opens on the lower surface of the support plate 42, and at the same time, extends linearly in the X direction. In other words, the individual interconnection groove 71 constitutes a lower end opening portion of the individual-use conducting portion 62. The individual interconnection groove 71 is disposed so as to traverse the plurality of individual recessed portions 70 in the X direction. The individual interconnection groove 71 is communicated with each of the individual recessed portions 70 through portions overlapping the individual recessed portions 70 in the plan view. In the individual-use conducting portion 62, a portion with which the individual recessed portion 70 and the individual interconnection groove 71 are communicated constitutes an individual penetration portion 73 penetrating the support plate 42 in the Z direction. It should be noted that the individual interconnection groove 71 is not limited to when straddling all the individual recessed portions 70, but is only required to straddle at least the individual recessed portions 70 adjacent to each other.

As shown in FIGS. 4 and 6, the intermediate plate 43 is stacked on the nozzle plate 39 to thereby reinforce the nozzle plate 39. The intermediate plate 43 covers a lower surface of the actuator plate 41. The intermediate plate 43 is bonded to the lower surface of the actuator plate 41 via an adhesive or the like. Thus, the intermediate plate 43 covers the lower end opening portions of the pressure chambers 50 in a lump. It is preferable for the intermediate plate 43 to be formed of a material more excellent in rigidity than the nozzle plate 39. However, the intermediate plate 43 may be formed of a material lower in rigidity than the nozzle plate 39 as long as the rigidity can be ensured together with the nozzle plate 39. In this case, a single layer structure or a laminate structure of a resin material, a metal material, glass, silicone, or the like can be adopted as the intermediate plate 43.

The intermediate plate 43 is provided with a plurality of communication holes 43a penetrating the intermediate plate 43 in the Z direction. The communication holes 43a respectively overlap the pressure chambers 50 in the plan view. In the first embodiment, the communication holes 43a each open in a central portion in the Y direction and the X direction of corresponding one of the pressure chambers 50.

In the actuator plate 41, the lower end surface of the drive portion 59 is located above the lower end surface of the partition portion 56. In other words, the lower end surface of the drive portion 59 is disposed in a state of being separated in the Z direction from an upper surface of the intermediate plate 43. In this case, a gap 77 formed between the lower surface of the drive portion 59 and the upper surface of the intermediate plate 43 constitutes a part of the pressure chamber 50. It should be noted that the gap 77 functions as an adhesive receiver when bonding the upper surface of the intermediate plate 43 to the actuator plate 41, or a space for a deformation of the drive portion 59 when ejecting the ink.

### <Nozzle Plate 39>

The nozzle plate 39 covers lower surfaces of the chip module 37 and the flow path frame member 31 in a lump. The nozzle plate 39 is bonded to the lower surfaces of the intermediate plate 43 and the flow path frame member 31 via an adhesive or the like. Thus, the nozzle plate 39 covers the lower end opening portions of the entrance common flow path 31b and the exit common flow path 31c, and the lower end opening portions of the communication holes 43a in a lump, and the nozzle plate 39 is formed of, for example, a resin material (polyimide or the like). However, the nozzle plate 39 may be formed of a metal material (SUS, Ni—Pd, or the like), glass, silicone, or the like besides the resin material.

The nozzle plate 39 is provided with a plurality of nozzle holes 39a penetrating the nozzle plate 39 in the Z direction. The nozzle holes 39a are each formed to have, for example, a taper shape having the inner diameter gradually decreasing along a direction from the upper side toward the lower side. The nozzle holes 39a overlap the communication holes 43a, respectively, in the plan view. Specifically, the nozzle holes 39a are respectively communicated with the pressure chambers 50 through the communication holes 43a.

It should be noted that in the first embodiment, it is sufficient for the communication hole 43a to be formed larger than at least the nozzle hole 39a. Specifically, the communication hole 43a may have a shape slightly larger than the nozzle hole 39a as in the illustrated example, or may have a shape equivalent to the pressure chamber 50.

Then, various types of interconnections provided to the head chip 32 will be described.

The head chip 32 is provided with common interconnections 81 and individual interconnections 82 as drive interconnections.

As shown in FIGS. 6 to 8, the common interconnection 81 is provided with a common electrode 81a, an end-surface routed interconnection 81b, an upper-surface routed interconnection 81c, a through interconnection 81d, and a common pad 81e.

The common electrode 81a is formed on at least an inner surface of each of the recessed portions 57 on the lower surface of the opposed portion 55. In the illustrated example, the common electrode 81a is formed over the entire inner surface of the recessed portion 57. In other words, the whole of the common electrode 81a faces the inside of the pressure chamber 50.

The end-surface routed interconnection 81b is formed on the +Y-side end surface in the opposed portion 55. In the first embodiment, the end-surface routed interconnection 81b is formed over the entire +Y-side end surface in the opposed portion 55. The end-surface routed interconnection 81b is coupled to the common electrode 81a in a boundary portion between the lower surface and the +Y-side end surface of the opposed portion 55.

As shown in FIGS. 4 and 5, the upper-surface routed interconnection 81c is formed on the +Y-side end portion of the upper surface of the opposed portion 55. The upper-surface routed interconnection 81c is formed to have a shape of a strip extending in the X direction on the upper surface of the opposed portion 55. The upper-surface routed interconnection 81c is coupled to the end-surface routed interconnection 81b in a boundary portion between the upper surface and the +Y-side end surface of the opposed portion 55. The upper-surface routed interconnection 81c is separated in the Y direction from the decoupling groove 58.

As shown in FIG. 8, the through interconnection 81d is for coupling the upper-surface routed interconnection 81c and the common pad 81e to each other, and is disposed so as to penetrate the support plate 42. The through interconnection 81d is formed on an inner surface of the common penetration portion 67. The through interconnection 81d is coupled to the upper-surface routed interconnection 81c at a lower end edge of the common penetration portion 67. It should be noted that it is sufficient for the through interconnection 81d to ensure the conduction over the entire length in the Z direction of the inner surface of the common penetration portion 67. In other words, the through interconnection 81d may be formed over, for example, the entire inner surface of the common penetration portion 67 in the circumferential direction, or may be formed on only a part thereof in the circumferential direction.

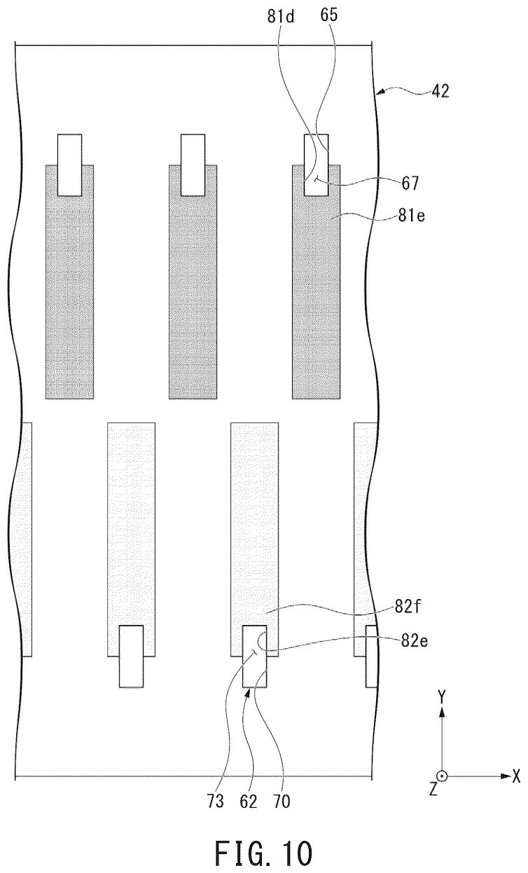

FIG. 10 is a plan view of the support plate 42.

As shown in FIGS. 4 and 10, the common pad 81e is formed on the upper surface of the support plate 42. The common pad 81e is coupled to the through interconnection 81d at the upper end opening edge of the common penetration portion 67.

As shown in FIGS. 4 and 6, the individual interconnections 82 are each provided with a first individual electrode 82a, a second individual electrode 82b, a third individual electrode 82c, an upper-surface routed interconnection 82d, a through interconnection 82e, and an individual pad 82f.

The first individual electrodes 82a are each formed on a portion overlapping each of the pressure chambers 50 in the plan view on the upper surface of the opposed portion 55. In the first embodiment, the first individual electrodes 82a are each formed on a portion overlapping the recessed portion 57 in the plan view on the upper surface of the opposed portion 55. Therefore, the first individual electrode 82a faces the common electrode 81a across the opposed portion 55 in the Z direction. On the upper surface of the opposed portion 55, the +Y-side end portion in the first individual electrode 82a is separated from the upper-surface routed interconnection 81c.

The second individual electrode 82b is formed on an inner surface of the decoupling groove 58 (the +X-side decoupling groove 58a) located at the +X side with respect to the pressure chamber 50. The second individual electrode 82b is formed over the inner surface facing the +X side and the bottom surface in the inner surfaces of the +X-side decoupling groove 58a. Therefore, the second individual electrode 82b faces the common electrode 81a across the +X-side drive portion 59a.

The third individual electrode 82c is formed on an inner surface of the decoupling groove 58 (the −X-side decoupling groove 58b) located at the −X side with respect to the pressure chamber 50. The third individual electrode 82c is formed over the inner surface facing the −X side and the bottom surface in the inner surfaces of the −X-side decoupling groove 58b. Therefore, the third individual electrode 82c faces the common electrode 81a across the −X-side drive portion 59b. The second individual electrode 82b corresponding to one pressure chamber 50 and the third individual electrode 82c corresponding to another pressure chamber 50 adjacent to the one pressure chamber 50 are separated on the bottom surface of the decoupling groove 58.

The upper-surface routed interconnection 82d couples, on the upper surface of the opposed portion 55, the first individual electrode 82a, the second individual electrode 82b, and the third individual electrode 82c disposed so as to correspond to one pressure chamber 50 to each other. The upper-surface routed interconnection 82d extends like a strip in the X direction in the −Y-side end portion on the upper surface of the opposed portion 55. The upper-surface routed interconnection 82d is coupled to the first individual electrode 82a in a central portion in the X direction. The upper-surface routed interconnection 82d is coupled to the second individual electrode 82b in the +X-side end portion. The upper-surface routed interconnection 82d is coupled to the third individual electrode 82c in the −X-side end portion.

The through interconnection 82e is for coupling the upper-surface routed interconnection 82d and the individual pad 82f to each other, and is disposed so as to penetrate the support plate 42. The through interconnection 82e is formed on an inner surface of the individual penetration portion 73. The through interconnection 82e is coupled to the upper-surface routed interconnection 82d at a lower end edge of the individual penetration portion 73. It should be noted that it is sufficient for the through interconnection 82e to ensure the conduction over the entire length in the Z direction of the inner surface of the individual penetration portion 73. In other words, the through interconnection 82e may be formed over, for example, the entire inner surface of the individual penetration portion 73 in the circumferential direction, or may be formed on only a part thereof in the circumferential direction.

As shown in FIGS. 4 and 10, the individual pad 82f is formed on the upper surface of the support plate 42. The individual pad 82f is coupled to the through interconnection 82e at the upper end opening edge of the individual penetration portion 73.

As shown in FIG. 6, the actuator plate 41 is provided with a protective film 88 which covers the actuator plate from below. The protective film 88 is disposed so as to cover the entire area of the inner surfaces of the pressure chamber 50 and the lower surface of the partition portion 56. Thus, the protective film 88 protects the common electrode 81a. The protective film 88 includes an organic insulating material such as a para-xylylene resin material (e.g., parylene (a registered trademark)) as a material having an insulating property. The protective films 88 can be formed of tantalum oxide (Ta₂O₅), silicon nitride (SiN), silicon carbide (SiC), silicon oxide (SiO₂), diamond-like carbon, or the like, or can include at least any one of these materials.

### <Flow Path Cover 34>

As shown in FIGS. 3 and 7, the flow path frame member 31 and the chip module 37 are tucked between the flow path cover 34 and a reinforcing plate 38. The flow path cover 34 is provided with a cover base 90, an entrance port 91, and an exit port 92.

The outer shape in the plan view of the cover base 90 is a rectangular plate shape formed to have an equivalent outer shape to the flow path frame member 31. The cover base 90 is stacked on the upper surface of each of the flow path frame member 31 and the chip module 37. The cover base 90 is bonded to the upper surface of each of the flow path frame member 31 and the chip module 37 via an adhesive or the like, and at the same time, is fastened to the flow path frame member 31 with screws or the like. Thus, the cover base 90 closes an upper end opening portion of each of the entrance common flow path 31b and the exit common flow path 31c.

A slit 90a is formed in a central portion in the Y direction of the cover base 90. The slit 90a penetrates the cover base 90 in the Z direction, and at the same time, extends in the X direction. The slit 90a is formed at a position overlapping the central portion (a portion excluding an outer circumferential portion) of the chip module 37. Specifically, the dimension in the Y direction of the slit 90a is smaller than the dimension in the Y direction of the chip module 37. The dimension in the X direction of the slit 90a is smaller than the dimension in the X direction of the chip module 37. The slit 90a exposes at least a part of the common pad 81e and the individual pad 82f on the upper surface of the support plate 42.

The entrance port 91 is located in an end portion at the +Y side and the +X side in the cover base 90. The entrance port 91 protrudes upward from the cover base 90. The entrance port 91 is communicated with the entrance common flow path 31b through the +X-side end portion (a portion protruding to the chip housing portion 31a) in the entrance common flow path 31b. In other words, the ink flowing through the ink supply tube 21 is supplied to the entrance common flow path 31b through the entrance port 91.

The exit port 92 is located in an end portion at the −Y side and the −X side in the cover base 90. The exit port 92 protrudes upward from the cover base 90. The exit port 92 is communicated with the exit common flow path 31c through the −X-side end portion (a portion protruding to the chip housing portion 31a) in the exit common flow path 31c. In other words, the ink flowing through the exit common flow path 31c is discharged to the ink discharge tube 22 through the exit port 92.

The flexible printed board 35 is pressure-bonded to the upper surface of the support plate 42 through the slit 90a. The flexible printed board 35 is coupled to the common pads 81e and the individual pads 82f on the upper surface of the support plate 42. The flexible printed board 35 is pulled out upward, and is then coupled to the control unit.

### [Operation Method of Printer 1]

Then, there will hereinafter be described when recording a character, a figure, or the like on the recording target medium P using the printer 1 configured as described above.

It should be noted that it is assumed that as an initial state, the sufficient ink having colors different from each other is respectively encapsulated in the four ink tanks 4 shown in FIG. 1. Further, there is provided a state in which the inkjet heads 5 are filled with the ink in the ink tanks 4 via the ink circulation mechanisms 6, respectively.

Under such an initial state, when making the printer 1 operate, the recording target medium P is conveyed toward the +X side while being pinched by the rollers 11, 12 of the conveyance mechanisms 2, 3. Further, by the carriage 29 moving in the Y direction at the same time, the inkjet heads 5 mounted on the carriage 29 reciprocate in the Y direction.

While the inkjet heads 5 make the reciprocal motion, the ink is appropriately ejected toward the recording target medium P from each of the inkjet heads 5. Thus, it is possible to perform recording of the character, the image, and the like on the recording target medium P.

Here, the operation of each of the inkjet heads 5 will hereinafter be described in detail.

In such a recirculating side-shoot type inkjet head 5 as in the first embodiment, first, by making the pressure pump 24 and the suction pump 25 shown in FIG. 2 operate, the ink is circulated in the circulation flow path 23. In this case, the ink circulating through the ink supply tube 21 is supplied to the inside of the entrance common flow path 31b through the entrance port 91. The ink supplied to the entrance common flow path 31b is distributed to the pressure chambers 50 through the +Y-side opening portion in each of the pressure chambers 50, and then flows through each of the pressure chambers 50 toward the −Y side. Subsequently, the ink is discharged to the exit common flow path 31c through the −Y-side opening portion of each of the pressure chambers 50. The ink discharged to the exit common flow path 31c flows into the ink discharge tube 22 through the exit port 92 to thereby be returned to the ink tank 4. Thus, it is possible to circulate the ink between the inkjet head 5 and the ink tank 4.

Then, when the reciprocation of the inkjet heads 5 is started due to the translation of the carriage 29 (see FIG. 1), the drive voltages are applied between the common electrodes 81a and the individual electrodes 82a to 82c via the flexible printed boards 35. On this occasion, the common electrode 81a is set at a reference potential GND, and the individual electrodes 82a to 82c are set at a drive potential Vdd to apply the drive voltage. Then, a potential difference occurs between the common electrode 81a and the individual electrodes 82a to 82c facing each other across the opposed portion 55 to thereby generate an electric field in the opposed portion 55.

Specifically, the potential difference occurs in the Z direction between the common electrode 81a and the first individual electrode 82a. Due to the potential difference having occurred in the Z direction, the electric field occurs in the opposed portion 55 in a direction parallel to the polarization direction (the Z direction). As a result, a stretch deformation in the Z direction occurs in the actuator plate 41 in a bend mode. Further, the potential difference occurs in the X direction between the common electrode 81a and the second individual electrode 82b, and between the common electrode 81a and the third individual electrode 82c. Since the electric field is generated in the drive portion 59 due to the potential difference generated in the X direction, the thickness-shear deformation in the Z direction occurs in the drive portion 59 in the shear mode. As a result, in the opposed portion 55, a shear deformation occurs upward in a portion corresponding to each of the pressure chambers 50 in a direction from both the end portions toward the central portion in the X direction. In other words, in the head chip 32 according to the first embodiment, it results in that both of the deformation caused by the shear mode and the deformation caused by the bend mode in the actuator plate 41 occur in the Z direction. Specifically, due to the application of the drive voltage, the actuator plate 41 (the opposed portion 55) deforms in a direction of getting away from the pressure chamber 50. Thus, the volume in the pressure chamber 50 expands.

Subsequently, when making the drive voltage zero, the opposed portion 55 is restored to thereby urge the volume in the pressure chamber 50 to be restored. In the process in which the actuator plate 41 is restored, the pressure in the pressure chamber 50 increases, and thus, the ink in the pressure chamber 50 is ejected outside through the communication hole 43a and the nozzle hole 39a. By the ink ejected outside landing on the recording target medium P, print information is recorded on the recording target medium P.

### <Method of Manufacturing Ejection Unit 30>

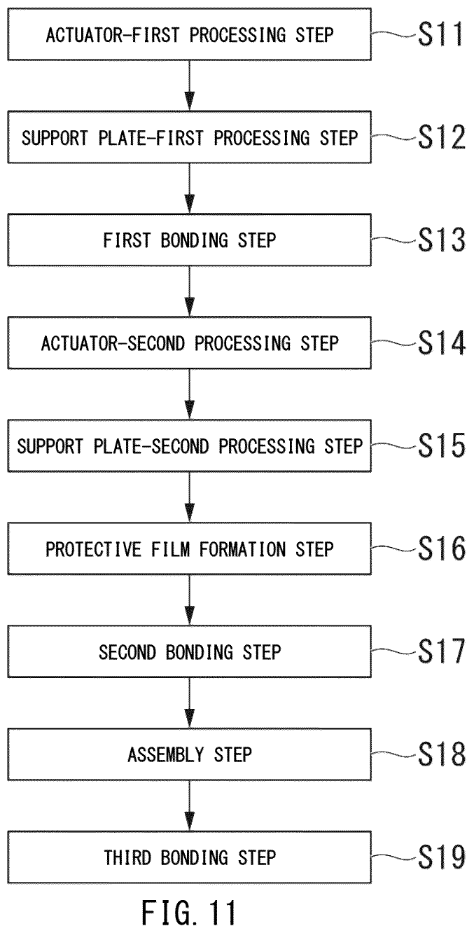

Then, the method of manufacturing the ejection unit 30 described above will be described. FIG. 11 is a flowchart describing a method of manufacturing the ejection unit 30.

As shown in FIG. 11, the method of manufacturing the ejection unit 30 is provided with an actuator-first processing step S11, a support plate-first processing step S12, a first bonding step S13, an actuator-second processing step S14, a support plate-second processing step S15, a protective film formation step S16, a second bonding step S17, an assembly step S18, and a third bonding step S19. In the following description, when manufacturing the chip module 37 chip by chip will be described as an example for the sake of convenience.

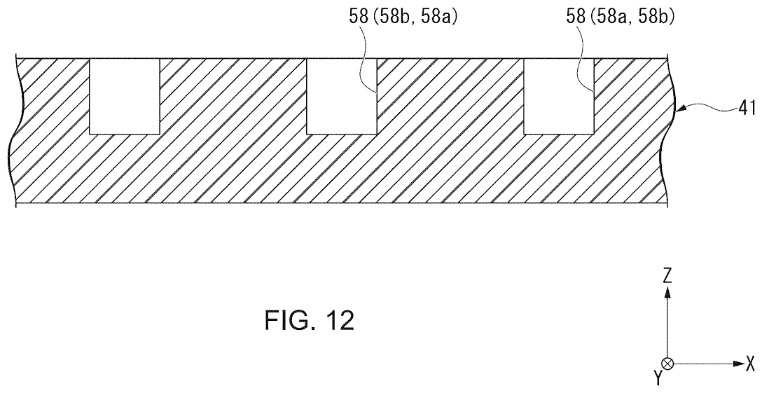

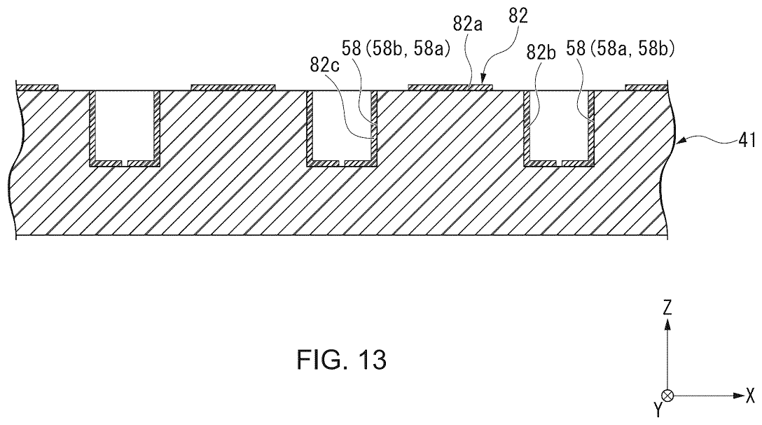

FIGS. 12 and 13 are process charts describing the actuator-first processing step S11, and are cross-sectional views corresponding to FIG. 6.

As shown in FIG. 12, in the actuator-first processing step S11, the decoupling grooves 58 are formed in the actuator plate 41 (a decoupling groove formation step). Specifically, the decoupling grooves 58 are formed by performing dicing processing or the like on the upper surface of the actuator plate 41.

Subsequently, as shown in FIG. 13, in the actuator-first processing step S11, portions (the individual electrodes 82a to 82c, the upper-surface routed interconnections 81c, 82d, and so on) located on the upper surface of the actuator plate 41 out of the drive interconnections are formed (a first interconnection formation step). In the first interconnection formation step, first, a mask pattern in which formation areas of the drive interconnections open is formed on the upper surface of the actuator plate 41. Then, an electrode material is deposited on the actuator plate 41 using, for example, oblique vapor deposition. The electrode material is deposited on the actuator plate 41 through opening portions of the mask pattern. Thus, the drive interconnections are formed on the upper surface of the actuator plate 41 and the inner surfaces of the decoupling grooves 58. Subsequently, by irradiating the bottom surfaces of the decoupling grooves 58 with a laser beam, the second individual electrode 82b corresponding to one pressure chamber 50 and the third individual electrode 82c corresponding to another pressure chamber 50 adjacent to the one pressure chamber 50 are separated from each other at each of the bottom surfaces of the decoupling grooves 58.

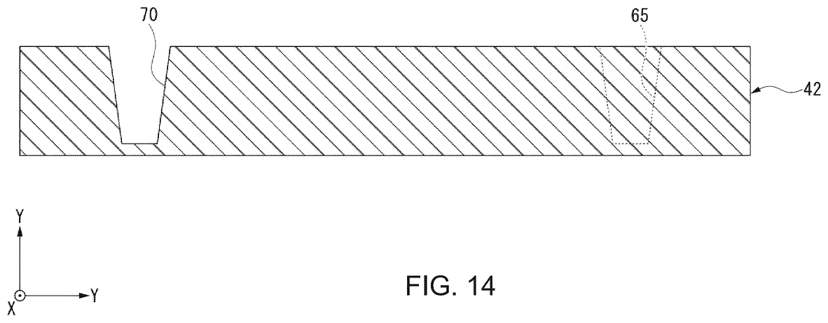

FIGS. 14 to 16 are process charts describing the support plate-first processing step S12, and are cross-sectional views corresponding to FIG. 7.

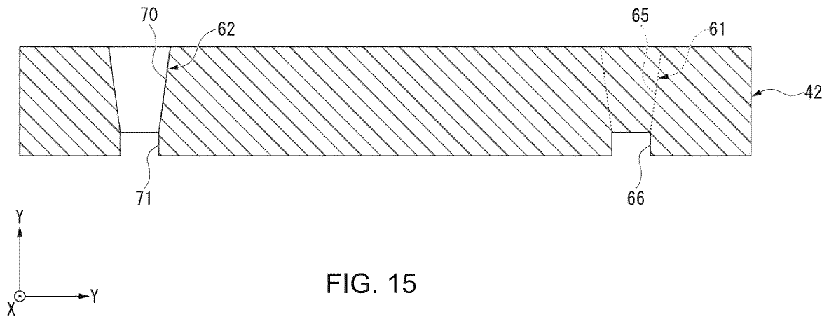

As shown in FIG. 14, in the support plate processing step S12, first, the conducting portions 61, 62 are provided to the support plate 42. Specifically, the common recessed portions 65 and the individual recessed portions 70 are provided to the upper surface of the support plate 42 by sandblast processing or the like. Subsequently, as shown in FIG. 15, the common interconnection groove 66 and the individual interconnection grooves 71 are provided to the lower surface of the support plate 42 by dicing processing or the like. On this occasion, the common interconnection groove 66 and the individual interconnection grooves 71 are formed so that the common interconnection groove 66 and the common recessed portions 65 are communicated with each other, and the individual interconnection grooves 71 and the individual recessed portions 70 are communicated with each other, respectively. Thus, the conducting portions 61, 62 are formed.

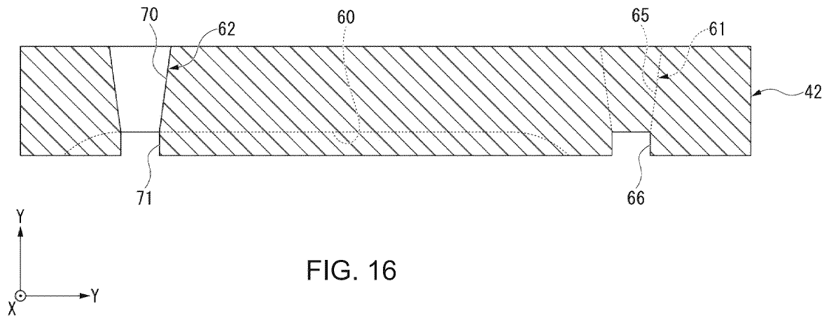

Subsequently, as shown in FIG. 16, in the support plate-first processing step S12, the deformation accepting portions 60 are formed. The deformation accepting portions 60 are formed on the lower surface of the support plate 42 by dicing processing or the like.

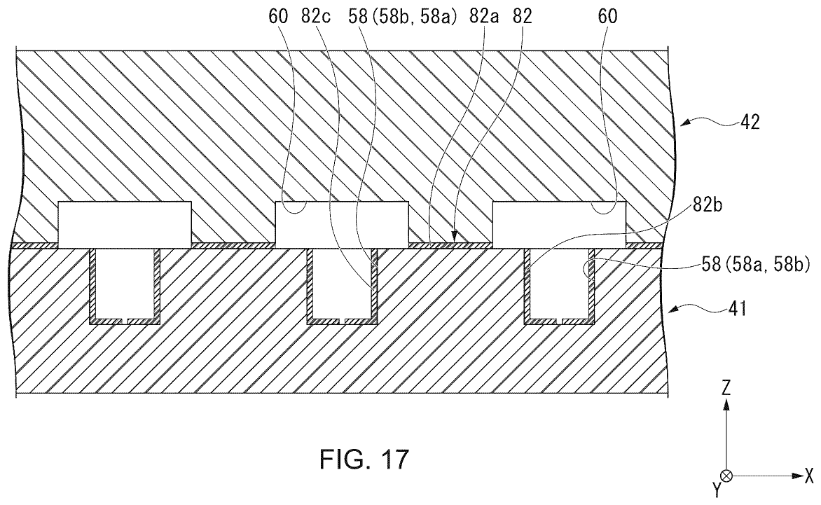

FIG. 17 is a process chart describing the first bonding step S13, and is a cross-sectional view corresponding to FIG. 6.

As shown in FIG. 17, in the first bonding step S13, the support plate 42 is attached to the upper surface of the actuator plate 41 with an adhesive or the like. In the first bonding step S13, a surplus adhesive forced to flow when pressure-bonding the actuator plate 41 and the support plate 42 to each other is retained in the common interconnection groove 66, the individual interconnection grooves 71, and the deformation accepting portions 60.

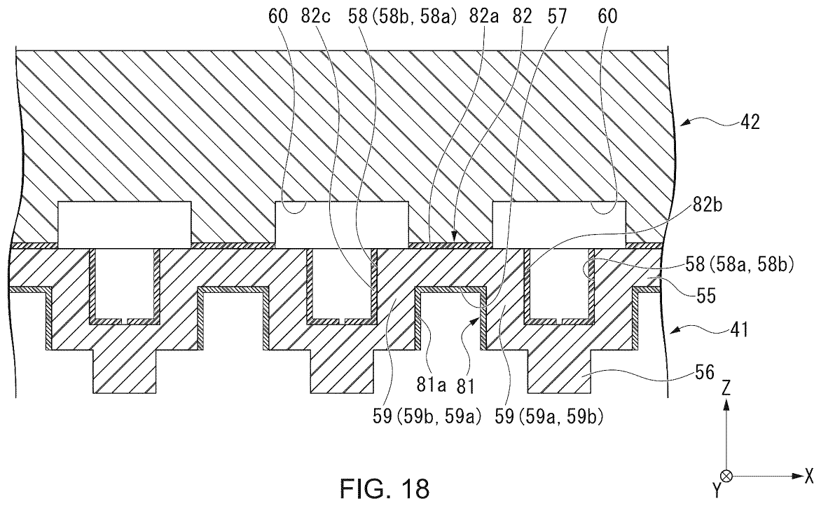

FIG. 18 is a process chart describing the actuator-second processing step S14, and is a cross-sectional view corresponding to FIG. 6.

As shown in FIG. 18, in the actuator-second processing step S14, grooves having a width corresponding to, for example, the recessed portions 57 are provided to the lower surface of the actuator plate 41 by dicing processing or the like. Subsequently, portions (the common electrodes 81a, the end-surface routed interconnections 81b, and so on) located on the lower surface and the +Y-side end surface of the actuator plate 41 out of the drive interconnections are formed (the second interconnection formation step). Subsequently, by performing, for example, dicing processing on the lower surface of the actuator plate 41, portions each corresponding to an area between the partition portions 56 adjacent to each other out of the pressure chambers 50 are formed.

It should be noted that in the actuator-second processing step S14, grinding processing or the like is appropriately performed in order to smooth the lower surface of the actuator plate 41. On this occasion, since the support plate 42 is stacked on the upper surface of the actuator plate 41, it results in that the grinding processing is performed on the lower surface of the actuator plate 41 in the state of being supported by the support plate 42.

In the support plate-second processing step S15, the through interconnections 81d, 82e and the pads 81e, 82f out of the drive interconnections are provided to the support plate 42 (the third interconnection formation step). Specifically, a mask pattern in which formation areas of the through interconnections 81d, 82e and the pads 81e, 82f open is formed on the upper surface of the support plate 42. Then, the electrode material is deposited on the support plate 42 using, for example, oblique vapor deposition from the Y direction. The electrode material is deposited on the support plate 42 through opening portions of the mask pattern. Thus, the through electrodes 81d, 82e and the pads 81e, 82f are formed.

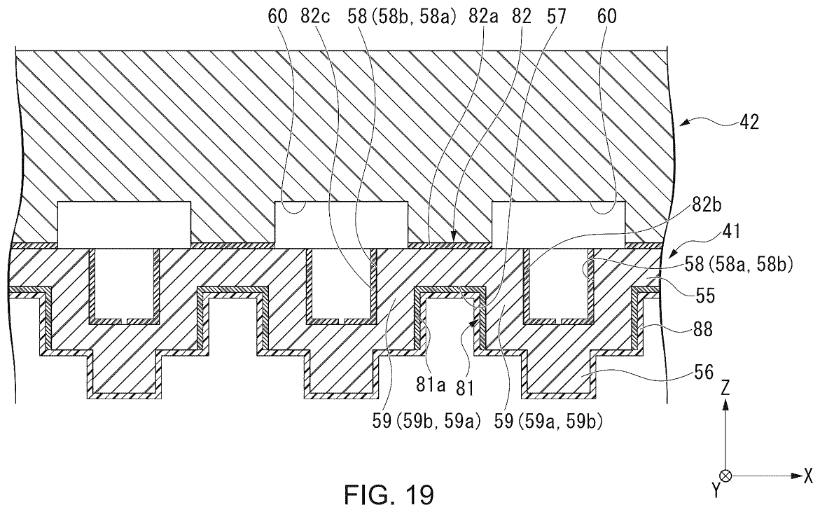

FIG. 19 is a process chart describing a protective film formation step S16, and is a cross-sectional view corresponding to FIG. 6.

As shown in FIG. 19, in the protective film formation step S16, the protective film 88 is formed on the lower surface of the actuator plate 41.

In the second bonding step S17, the intermediate plate 43 is attached to the lower surface of the actuator plate 41 with an adhesive or the like.

In this way, the chip module 37 is completed.

Subsequently, in the assembly step S18, the chip module 37 is assembled to the flow path frame member 31. Specifically, the chip module 37 is fitted in the chip housing portion 31a so that the lower surface of the flow path frame member 31 and the lower surface of the chip module 37 are arranged to be coplanar with each other.

Subsequently, in the third bonding step S19, the nozzle plate 39 is attached so as to cover the lower surface of the flow path frame member 31 and the lower surface of the chip module 37 in a lump. Subsequently, the flow path cover 34 is attached to the upper surface of the flow path frame member 31.

In this way, the ejection unit 30 is completed.

As described above, the head chip 32 according to the first embodiment is provided with the actuator plate 41 having the opposed portion 55 provided with the recessed portions (recessed portions) 57 formed on the lower surface (a first surface) and the decoupling grooves (recessed portions) 58 formed on the upper surface (a second surface), the common electrodes 81a which are disposed on the lower surface of the opposed portion 55 and function as the reference potential GND, and the individual electrodes 82a to 82c disposed on the upper surface of the opposed portion 55 which is a surface other than the lower surface of the opposed portion 55. The common electrode 81a out of the common electrode 81a and the individual electrodes 82a to 82c is formed on at least the inner surfaces of the recessed portion 57. The individual electrodes 82b, 82c are formed on at least the inner surfaces of the decoupling groove 58.

According to this configuration, since the recessed portions 57 and the decoupling grooves 58 are provided to the actuator plate 41, it is easy to ensure the rigidity of the whole of the actuator plate 41. Therefore, it is possible to achieve an increase in manufacturing efficiency and an increase in yield ratio. On that basis, in the first embodiment, since the drive interconnections are also formed in the recessed portions 57 and the decoupling grooves 58, it is possible to ensure the surface area of the drive electrodes (the common electrodes 81a and the individual electrodes 82b, 82c), and at the same time, it is easy to ensure the facing area between the common electrode 81a and the individual electrodes 82b, 82c. Therefore, it is possible to increase the pressure to be generated in the pressure chamber 50 when ejecting the ink.

In particular, in the first embodiment, since the individual electrodes 82a to 82c are formed on the upper surface of the opposed portion 55, it results in that only the common electrode 81a is formed on the lower surface of the opposed portion 55. Therefore, it is possible to suppress the short circuit between common electrode 81a and the individual electrodes 82b, 82c via the ink compared to the configuration in which the common electrodes 81a and the individual electrodes 82b, 82c are disposed on the lower surface of the opposed portion 55. Thus, it is possible to provide the head chip 32 excellent in durability and reliability.

In the head chip 32 according to the first embodiment, the actuator plate 41 has the polarization direction set to the Z direction (the thickness direction), the recessed portion (a first recessed portion) 57 formed on the lower surface of the opposed portion 55 is disposed in a portion opposed to the pressure chamber 50 when viewed from the Z direction, and the decoupling groove (a second recessed portion) 58 formed on the upper surface of the opposed portion 55 is disposed at a position shifted from the recessed portion 57 when viewed from the Z direction.

According to this configuration, the electric field occurs in the drive portion 59 of the actuator plate 41 due to the potential difference generated between the common electrode 81a provided to the recessed portion 57 and the individual electrodes 82b, 82c formed in the decoupling groove 58. Thus, the drive portion 59 deforms in the Z direction of the actuator plate 41 in a so-called shear mode. As a result, it is easy to ensure the deformation amount of the actuator plate 41 to ensure the pressure generated in the pressure chamber 50.

In the head chip 32 according to the first embodiment, the first individual electrode 82a is formed on a portion other than the decoupling groove 58 on the upper surface of the opposed portion 55.

According to this configuration, by generating the potential difference between the first individual electrode 82a and the common electrode 81a, it is possible to generate the electric field in the Z direction of the actuator plate 41. Thus, it is possible to deform the actuator plate 41 in the Z direction in the bend mode (a bimorph type). Thus, a further increase in the generated pressure can be achieved.

In the head chip 32 according to the first embodiment, the actuator plate 41 is formed as a unit having the polarization direction set to the Z direction.

According to this configuration, by using the actuator plate 41 of a so-called monopole type in which the polarization direction is set to one direction, no junction plane exists between the piezoelectric materials unlike when, for example, the actuator plate is configured by stacking a plurality of piezoelectric materials different in polarization direction. Therefore, it is possible to suppress the ink bridge between the common electrode 81a and the individual electrodes 82a to 82c occurring through the junction interface in the actuator plate 41. As a result, the possibility of the short circuit can be reduced.

In the head chip 32 according to the first embodiment, the protective film 88 which covers the common electrode 81a is disposed in the actuator plate 41 on the lower surface of the opposed portion 55.

According to this configuration, by covering the common electrode 81a with the protective film 88, it is possible to suppress the contact between the common electrode 81a and the ink to improve the durability of the common electrode 81a.

In the head chip 32 according to the first embodiment, there is provided the nozzle plate (a jet hole plate) 39 which is penetrated by the plurality of jet holes 39a respectively communicated with the plurality of pressure chambers 50, and is disposed so as to face the actuator plate 41 in the Z direction. The actuator plate 41 is provided with the opposed portion 55 disposed in the state of being separated in the Z direction from the nozzle plate 39, and the partition portions 56 which are formed integrally with the opposed portion 55, and separate the pressure chambers 50 adjacent to each other. In the opposed portion 55, a portion located between the recessed portion 57 and the decoupling groove 58 adjacent to each other includes the drive portion 59 in which the electric field occurs due to the common electrode 81a and the individual electrodes 82b, 82c, and at least a part of the partition portion 56 is disposed at a position which does not overlap the drive portion 59 when viewed from the Z direction.

According to this configuration, the electric field occurs in the drive portion 59 due to the potential difference generated between the common electrode 81a provided to the recessed portion 57 and the individual electrodes 82b, 82c formed in the decoupling groove 58. Thus, by the drive portion 59 deforming in the Z direction in the so-called shear mode, it is possible to eject the ink through the nozzle hole 39a.

In particular, in the first embodiment, since at least a part of the partition portion 56 is disposed at the position which does not overlap the drive portion 59 when viewed from the Z direction, it results in that a gap occurs in the Z direction between the nozzle plate 39 and the drive portion 59. Therefore, inhibition of the deformation of the drive portion 59 by the nozzle plate 39 or the intermediate plate 43 can be relieved when ejecting the ink. As a result, it is easy to ensure the deformation amount of the actuator plate 41 to ensure the pressure generated in the pressure chamber 50.

Moreover, in the first embodiment, the partition portion 56 also functions as at least a part of the partition portion 56 which separates the pressure chambers 50 adjacent to each other. Thus, it is possible to improve the position accuracy in the X direction (the arrangement direction of the pressure chambers 50) between the drive portion 59 and the partition portion 56 compared to the configuration in which the whole of the partition portion 56 is formed of a separate member from the actuator plate 41.

Since the inkjet head 5 and the printer 1 according to the first embodiment are each provided with the head chip 32 described above, it is possible to provide the inkjet head 5 and the printer 1 which are excellent in reliability.

### Second Embodiment

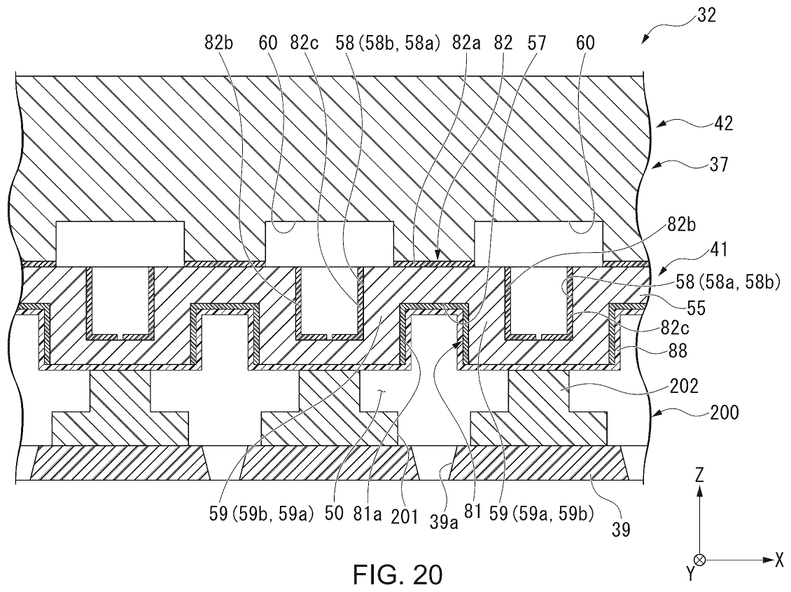

FIG. 20 is a cross-sectional view of a head chip 32 according to a second embodiment. The second embodiment is different from the first embodiment in the point that the actuator plate 41 is not provided with the partition portions 56.

In the head chip 32 shown in FIG. 20, a flow path plate 200 is disposed between the actuator plate 41 and the nozzle plate 39. The flow path plate 200 is bonded to the lower surface of the actuator plate 41 via an adhesive or the like. To the flow path plate 200, there is provided a plurality of individual flow paths 201. Each of the individual flow paths 201 constitutes the pressure chamber 50 together with the recessed portion 57 corresponding to the individual flow path 201. The individual flow paths 201 are disposed at intervals in the X direction so as to penetrate the flow path plate 200 in the Y direction and the Z direction. It should be noted that, in the flow path plate 200, a portion located between the pressure chambers 50 adjacent to each other functions as a partition portion 202 which separates the pressure chambers 50 adjacent to each other.

The individual flow paths 201 are each formed to have a step shape in which the width in the X direction in a portion located at an upper side is wider than the width in the X direction of a portion located at a lower side in the cross-sectional view shown in FIG. 20. A lower end opening portion of each of the individual flow paths 201 is communicated with the nozzle hole 39a corresponding to that individual flow path 201. It should be noted that the width in the X direction in the individual flow path 201 may be uniform throughout the entire length in the Z direction.

According to this configuration, by forming the partition portion 202 of the pressure chamber 50 with the flow path plate 200 which is a separate body from the actuator plate 41, it is possible to thin the actuator plate 41. Thus, it is easy to ensure the amount of the deformation of the actuator plate 41 caused by the electric field generated in the actuator plate 41.

### Third Embodiment

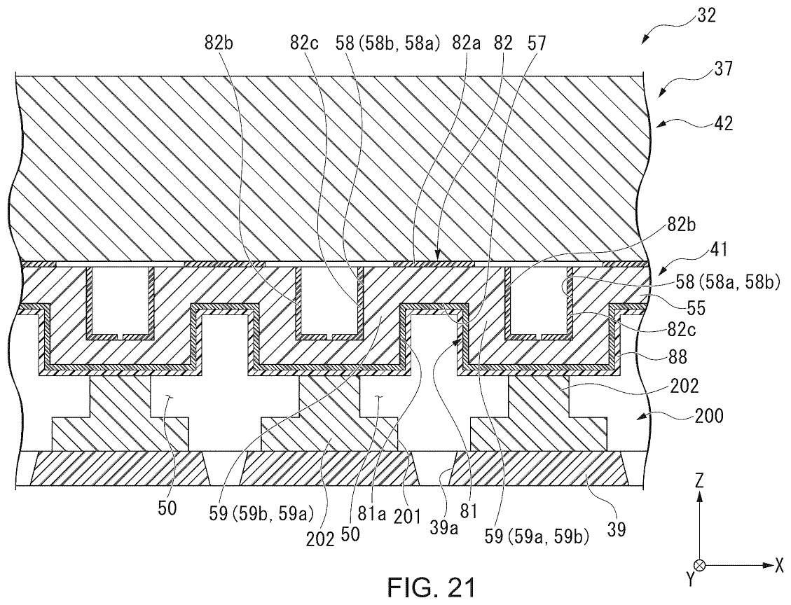

FIG. 21 is a cross-sectional view of a head chip 32 according to a third embodiment.

In the head chip 32 shown in FIG. 21, the common electrode 81a is formed over the entire area of the lower surface of the opposed portion 55 including the inner surfaces of the recessed portion 57. In other words, the common electrode 81a is formed in a lump with respect to all the pressure chambers 50.

According to this configuration, patterning and so on of the common electrode 81a become unnecessary on the lower surface of the actuator plate 41, and therefore, it is possible to achieve an increase in manufacturing efficiency and a reduction in cost. It should be noted that in the third embodiment, there is described the configuration in which the common electrode 81a is continuously provided to all the pressure chambers 50, but this configuration is not a limitation. The common electrode 81a may be formed in a lump for any plurality of pressure chambers 50 out of all the pressure chambers 50.

Further, in each of the embodiments described above, there is described the configuration in which the deformation accepting portions 60 are provided to the support plate 42, but this configuration is not a limitation. As in the third embodiment, the deformation accepting portion 60 is not an essential element.

### Fourth Embodiment

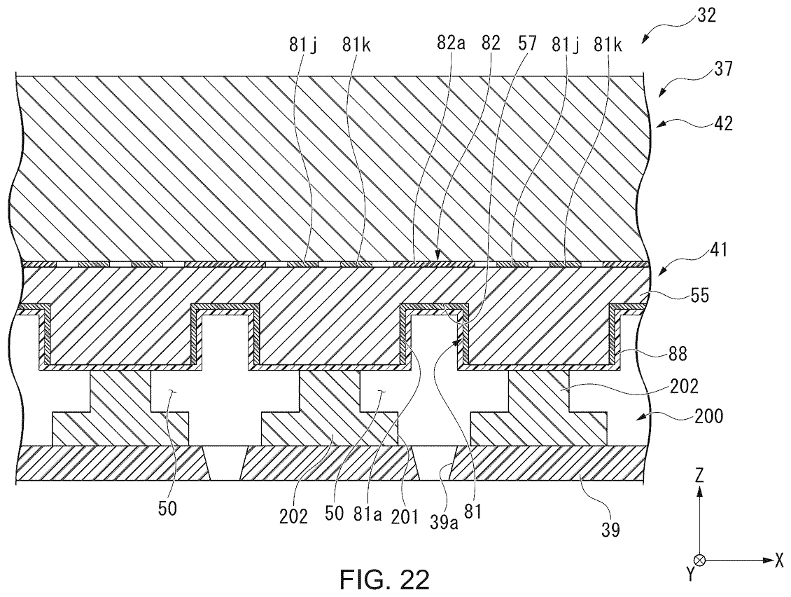

FIG. 22 is a cross-sectional view of a head chip 32 according to a fourth embodiment. The fourth embodiment is different from each of the embodiments described above in the point that the decoupling grooves 58 are not formed, and the point that the upper surface of the actuator plate 41 is also provided with common electrodes 81j, 81k.

In the head chip 32 shown in FIG. 22, the upper surface of the actuator plate 41 is provided with the second common electrodes 81j and the third common electrodes 81k.

The second common electrodes 81j are each formed on a portion located at the +X side with respect to the first individual electrode 82a on the upper surface of the actuator plate 41, and at a position overlapping a +X-side end portion in the pressure chamber 50 in the plan view.

The third common electrodes 81k are each formed on a portion located at the −X side with respect to the first individual electrode 82a on the upper surface of the actuator plate 41, and at a position overlapping a −X-side end portion in the pressure chamber 50 in the plan view.

According to this configuration, a potential difference occurs in the X direction between the first individual electrode 82a and the second common electrode 81j, and between the first individual electrode 82a and the third common electrode 81k. Due to the potential difference having occurred in the X direction, an electric field occurs in the actuator plate 41 in a direction perpendicular to the polarization direction (the Z direction). As a result, the thickness-shear deformation occurs in the actuator plate 41 in the Z direction in the shear mode.

On that basis, in the fourth embodiment, since the decoupling grooves 58 are not provided, it is possible to suppress an occurrence of a chip or the like of the actuator plate 41 to enhance handling. As a result, it is possible to achieve an increase in manufacturing efficiency and an increase in yield ratio.

### Fifth Embodiment

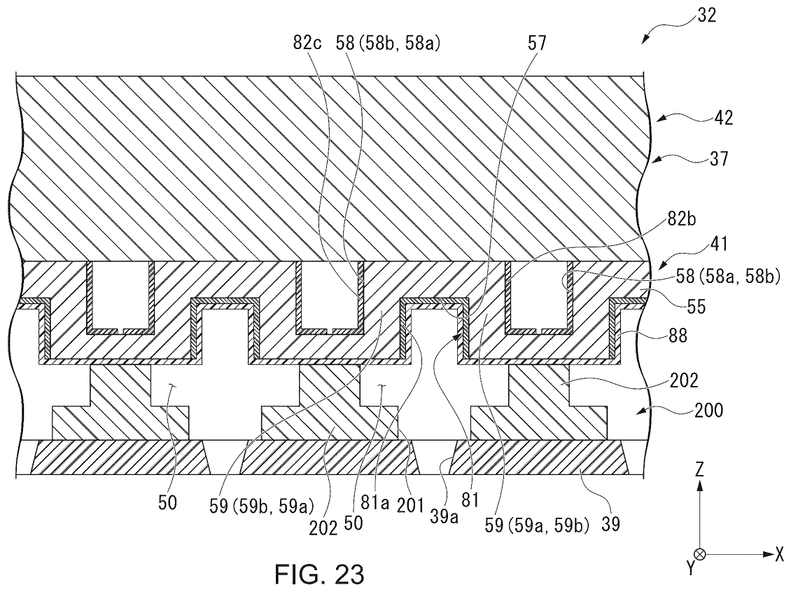

FIG. 23 is a cross-sectional view of a head chip 32 according to a fifth embodiment.

The individual interconnections 82 may have a configuration without the first individual electrodes 82a as in the head chip 32 shown in FIG. 23. Specifically, the head chip 32 according to the fifth embodiment is provided with the second individual electrodes 82b and the third individual electrodes 82c as the individual electrodes 82.

According to this configuration, since the first individual electrodes 82a are not provided to the upper surface of the actuator plate 41, routing of the drive interconnections becomes easy.

### Sixth Embodiment

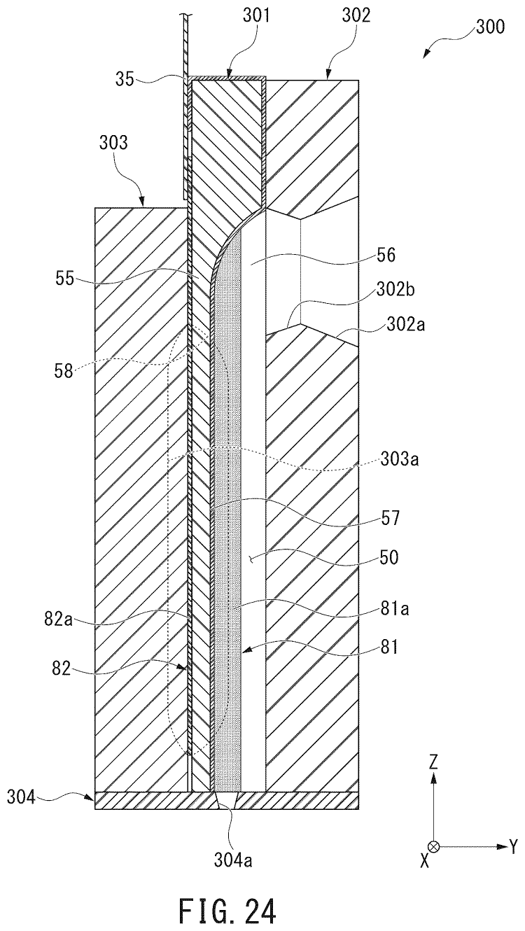

FIG. 24 is a cross-sectional view of a head chip 300 according to a sixth embodiment. The sixth embodiment is different from each of the embodiments described above in the point that the head chip 300 of a so-called edge-shoot type is adopted.

The head chip 300 shown in FIG. 24 is provided with an actuator plate 301, a cover plate 302, a support plate 303, and a nozzle plate 304.

Similarly to the first embodiment described above, the actuator plate 301 is provided with the plurality of pressure chambers 50 arranged side by side in the X direction. In the pressure chamber 50 in the present embodiment, a −Z-side end portion is opened on the lower surface of the actuator plate 301, and a +Z-side end portion is closed.

The cover plate 302 is stacked on the actuator plate 301 at the +Y side. In the cover plate 302, at a position overlapping an upper portion of the pressure chamber 50 when viewed from the Y direction, there is formed a common ink chamber 302a. The common ink chamber 302a extends in the X direction with a length sufficient for straddling, for example, a plurality of pressure chambers 50, and at the same time, opens on a surface facing the +Y side of the cover plate 302.

In the cover plate 302, at a position overlapping the pressure chambers 50 when viewed from the Y direction, there is formed a slit 302b. The slit 302b allows the common ink chamber 302a to individually communicate with each of the pressure chambers 50.

The support plate 303 is stacked on the actuator plate 301 at the −Y side. In the support plate 303, deformation accepting portions 303a are provided to a surface facing the +Y side similarly to the first embodiment.

The nozzle plate 304 covers lower surfaces of the actuator plate 301, the cover plate 302, and the support plate 303 in a lump. In the nozzle plate 304, portions overlapping the pressure chambers 50 in the plan view are provided with nozzle holes 304a, respectively.

According to this configuration, the ink in the common ink chamber 302a flows into the pressure chamber 50 through the slit 302b. The ink in the pressure chamber 50 is ejected to the outside through the nozzle hole 304a by a change in pressure in the pressure chamber 50 due to application of the drive voltage. cl Other Modified Examples

It should be noted that the scope of the present disclosure is not limited to the embodiments described above, but a variety of modifications can be applied within the scope or the spirit of the present disclosure.

For example, in the embodiments described above, the description is presented citing the inkjet printer 1 as an example of the liquid jet recording apparatus, but the liquid jet recording apparatus is not limited to the printer. For example, a facsimile machine, an on-demand printing machine, and so on can also be adopted.

In the embodiments described above, the description is presented citing the configuration (a so-called shuttle machine) in which the inkjet heads move with respect to the recording target medium when performing printing as an example, but this configuration is not a limitation. The configuration related to the present disclosure can be adopted as the configuration (a so-called stationary head machine) in which the recording target medium is moved with respect to the inkjet heads in the state in which the inkjet heads are fixed.

In the embodiments described above, there is explained when the recording target medium P is paper, but this configuration is not a limitation. The recording target medium P is not limited to paper, but can also be a metal material or a resin material, and can also be food or the like.

In the embodiments described above, there is explained the configuration in which the liquid jet heads are installed in the liquid jet recording apparatus, but this configuration is not a limitation. Specifically, the liquid to be jetted from the liquid jet heads is not limited to what is landed on the recording target medium, but can also be, for example, a medical solution to be blended during a dispensing process, a food additive such as seasoning or a spice to be added to food, or fragrance to be sprayed in the air.

In the embodiments described above, there is explained the configuration in which the Z direction coincides with the gravitational direction, but this configuration is not a limitation, and it is also possible to set the Z direction to a direction along the horizontal direction.

In the embodiments described above, there is described the configuration in which the actuator plate 41 is provided with the decoupling grooves 58 and the recessed portions 57, but this configuration is not a limitation. It is sufficient to provide at least one of the first recessed portion and the second recessed portion to the actuator plate 41. Further, the first recessed portion and the second recessed portion may be formed at positions overlapping each other in the plan view.

In each of the embodiments described above, there is described the configuration in which the pressure chamber 50 is formed to have a groove shape linearly penetrating the chip module 37 in the Y direction, but this configuration is not a limitation. The pressure chamber 50 can appropriately be changed to, for example, a circular shape in the plan view. Even when, for example, the pressure chamber 50 is formed to have a circular shape, it is preferable for the deformation accepting portion to extend along the outer circumferential portion of the pressure chamber 50 in the plan view.

In the embodiments described above, there is described the configuration in which the actuator plate 41 is deformed in both the bend mode and the shear mode, but this configuration is not a limitation. It is sufficient for the actuator plate 41 to be deformed in at least either one of the bend mode and the shear mode.

In the embodiments described above, there is described the configuration in which the pressure chambers 50 adjacent to each other are separated by only either one of the partition portion 56 of the actuator plate 41 and the partition portion 202 of the flow path plate 200, but this configuration is not a limitation. The pressure chambers 50 adjacent to each other may be separated by both the partition portion 56 of the actuator plate 41 and the partition portion 202 of the flow path plate 200.

In the embodiments described above, there is described the configuration in which the individual electrodes are provided only to the upper surface of the actuator plate 41 (the opposed portion 55), but this configuration is not a limitation. The individual electrodes may be separately provided to a surface different from the lower surface as long as the individual electrodes are provided to at least the upper surface of the actuator plate 41.

Besides the above, it is arbitrarily possible to replace the constituents in the embodiments described above with known constituents within the scope or the spirit of the present disclosure, and it is also possible to arbitrarily combine the modified examples described above with each other.

What is claimed is:

1. A head chip comprising:
an actuator plate which has a first surface facing a plurality of pressure chambers containing a liquid, and a second surface facing an opposite side to the pressure chambers with respect to the first surface in a thickness direction, and in which a recessed portion is provided on at least one surface out of the first surface and the second surface;
a common electrode provided to the first surface, and configured to function as a reference potential; and
an individual electrode provided to the second surface which is a surface other than the first surface, and configured to generate a potential difference relative to the common electrode to generate an electric field in the actuator plate, wherein
an electrode which is one of the common electrode and the individual electrode and is provided to the one surface is provided on at least an inner surface of the recessed portion.

2. The head chip according to claim 1, wherein
a polarization direction of the actuator plate is set to the thickness direction,
the recessed portion is provided on each of the first surface and the second surface,
a first recessed portion which is the recessed portion provided to the first surface is disposed in a portion facing the pressure chamber when viewed from the thickness direction, and
a second recessed portion which is the recessed portion provided to the second surface is disposed at a position shifted from the first recessed portion when viewed from the thickness direction.

3. The head chip according to claim 2, wherein
the individual electrode is formed on a portion of the second surface other than the second recessed portion.

4. The head chip according to claim 1, wherein
the common electrode is formed over an entire area of the first surface.

5. The head chip according to claim 1, wherein
the actuator plate is formed as a unit having a polarization direction set to the thickness direction.

6. The head chip according to claim 1, wherein
the actuator plate is provided with a protective film configured to cover the common electrode on the first surface.

7. The head chip according to claim 1, further comprising
a jet hole plate which is penetrated, in the thickness direction, by a plurality of jet holes respectively communicated with the plurality of pressure chambers, and which is disposed so as to face the actuator plate in the thickness direction, wherein
the actuator plate includes
an opposed portion which has the first surface and the second surface, and is disposed in a state of being separated in the thickness direction from the jet hole plate, and
a partition portion formed integrally with the opposed portion, protruding from the opposed portion in the thickness direction, and configured to separate the pressure chambers adjacent to each other,
a first recessed portion which is the recessed portion provided to the first surface is disposed in a portion facing the pressure chamber when viewed from the thickness direction,
a second recessed portion which is the recessed portion provided to the second surface is disposed at a position shifted from the first recessed portion when viewed from the thickness direction,
the common electrode is provided to an inner surface of the first recessed portion,
the individual electrode is provided to an inner surface of the second recessed portion,
the opposed portion includes, in a portion located between the first recessed portion and the second recessed portion adjacent to each other, a drive portion in which an electric field is generated by the common electrode and the individual electrode, and
at least a part of the partition portion is disposed at a position which does not overlap the drive portion when viewed from the thickness direction.

8. A liquid jet head comprising:
the head chip according to claim 1.

9. A liquid jet recording apparatus comprising:
the liquid jet head according to claim 8.
